(19) United States
(12) Patent Application Publication
(10) Pub. No.: US 2011/0290837 A1
(43) Pub. Date: Dec. 1, 2011

(54) RACK LOCK SAFETY MECHANISM FOR A WEAPON

(76) Inventor: Arnold SMITH, Victorville, CA (US)

(21) Appl. No.: 13/117,261

(22) Filed: May 27, 2011

Related U.S. Application Data
(60) Provisional application No. 61/349,840, filed on May 29, 2010.

(51) Int. Cl. B62J 9/00; F41A 17/00; B60R 11/00

(52) U.S. Cl. 224/413; 224/545; 42/70.11

(57) ABSTRACT

A rack lock safety mechanism for securely locking a weapon that includes a main frame, a safety-lock module coupled with the main frame, and a lock mechanism coupled with the main frame.

### CROSS-REFERENCE TO RELATED APPLICATIONS

This Application claims the benefit of priority of U.S. Utility Provisional Patent Application No. 61/349,840, filed 29 May 2010, the entire disclosures of all Applications are expressly incorporated by reference in their entirety herein.

### BACKGROUND OF THE INVENTION

1. Field of the Invention

This invention relates to carrying and concealing a weapon such as a rifle and more particularly, to carrying a weapon such as a rifle securely locked and concealed within an optional casing of a law enforcement motorcycle.

2. Description of Related Art

Conventional rack locks for mounting and locking a rifle on a motorcycle have been used for years. In general, rifles are mounted on conventional rack locks that are mounted on top or side of a motorcycle with the locked weapon exposed to the public and the elements. It is important to conceal the rifle carried by law enforcement from the public view for safety and security of both the officer and the public, and to keep the weapon out of elements. However, unlike law enforcement patrol cars that have plenty of space to conceal and carry a weapon (e.g., within the vehicle or in a trunk), most conventional motorcycles used by law enforcement offices do not have sufficient covered space to conceal and carry a locked rifle.

Accordingly, in light of the current state of the art and the drawbacks to weapon rack lock systems mentioned above, a need exists for a rack lock safety mechanism for a rifle that enables users to lock and carry an unloaded weapon in a concealed manner. In addition, a need exists for a rack lock mechanism for a rifle that prevents users from loading or reloading the weapon while the rifle is locked on a rack lock.

### BRIEF SUMMARY OF THE INVENTION

An exemplary, non-limiting optional aspect of the present invention provides a device, comprising:
a hard casing for carrying a locked and substantially concealed weapon;
a rack lock safety mechanism for securely locking the weapon, with the rack lock safety mechanism mounted within the hard casing to maintain the securely locked weapon substantially concealed, out of view of public, and out of elements.

Another exemplary, non-limiting optional aspect of the present invention provides a device, further comprising:

an external support coupled with the hard casing for supporting a weight of the hard casing, including the securely locked weapon locked within the rack lock safety mechanism that is mounted within the hard casing.

Still another exemplary, non-limiting optional aspect of the present invention provides a device, wherein:
the hard casing has a substantially teardrop configuration comprised of a first piece that mounts on a motorcycle that is pivotally coupled with a second piece by a hinge mechanism that is positioned longitudinally along an axial length of the hard casing;
the hard casing includes a lateral end with an opening to enable a small portion of the weapon to extend out.

Yet another exemplary, non-limiting optional aspect of the present invention provides a device, wherein:

the rack lock safety mechanism is mounted within the hard casing using fasteners, with the hard casing securely mount onto the external support.

A further exemplary, non-limiting optional aspect of the present invention provides a device, wherein:

the rack lock safety mechanism is mounted within the hard casing using a same set of fasteners that securely mount the hard casing onto the external support, with the fasteners extended from the external support and through the hard casing, enabling locking and secure mounting of the rack lock safety mechanism together within the hard casing and onto the external support.

Yet a further exemplary, non-limiting optional aspect of the present invention provides a device, wherein:

the rack lock safety mechanism is comprised of:

a main frame,

a safety-lock module; and

a lock mechanism.

Still a further exemplary, non-limiting optional aspect of the present invention provides a device, wherein:
the main frame is comprised of:
a base with a base-width and a base-length providing sufficient base-span for stability of the rack lock safety mechanism to withstand forces, with the base having a base-perimeter configured commensurate with accommodations provided by an interior bottom of the hard casing.

Another exemplary, non-limiting optional aspect of the present invention provides a device, wherein:
the main frame is further comprised of a stand coupled with the base;
the vertical portion supports weight of the lock mechanism and the weapon at an elevation from the base.

Still another exemplary, non-limiting optional aspect of the present invention provides a device, wherein:

the stand is comprised of:

a first and second periphery edges that are coupled with the base-stand, a bottom edge coupled with the base, and a top edge.

Yet another exemplary, non-limiting optional aspect of the present invention provides a device, wherein:

the top edge of the stand is comprised of:

an arced bend defining a first corner between the top edge and the first periphery edge;

a sustainably flat, sloping portion, and

a second corner between the top edge and the second periphery edge, with the second corner positioned at a lower height from the first corner to thereby form a top edge that is slanted at a slope the first corner to the second corner.

A further exemplary, non-limiting optional aspect of the present invention provides a device, wherein:

the top edge of the stand is comprised of:

a first corner and a second corner, with the second corner positioned at a lower height from the first corner to thereby form a slanted sloping edge.

Still a further exemplary, non-limiting optional aspect of the present invention provides a device, wherein:

the top edge of the stand is substantially straight.

Yet a further exemplary, non-limiting optional aspect of the present invention provides a device, wherein:

the main frame is further comprised of:

a brace for added support for added structural integrity for the stand, providing added strength to prevent the stand from being bent.

Another exemplary, non-limiting optional aspect of the present invention provides a device, wherein:

the brace has a first end coupled with a side of the stand.

Still another exemplary, non-limiting optional aspect of the present invention provides a device, wherein:

the brace has a first end coupled with a side of the stand, and a second end coupled with the base.

Yet another exemplary, non-limiting optional aspect of the present invention provides a device, wherein:

the brace is rod.

A further exemplary, non-limiting optional aspect of the present invention provides a device, wherein:

the brace is comprised of a quadrilateral configuration coupled with a base at a first-side, and coupled with a periphery edge of the stand at a second-side, with the third and forth sides free.

Still a further exemplary, non-limiting optional aspect of the present invention provides a device, wherein:

the brace is comprised of a quadrilateral of a trapezoid configuration coupled with a base at a first-side, and coupled with a periphery edge of the stand at a second-side, with the third and forth sides free.

Yet a further exemplary, non-limiting optional aspect of the present invention provides a device, wherein:

the main frame is further comprised of:

a top mount that enables the mounting of the lock mechanism there-under.

Another exemplary, non-limiting optional aspect of the present invention provides a device, wherein:

the top mount is connected to the substantially flat, sloping portion of the top edge of the stand, and is cantilevered with an axial length of the top mount extended transverse, normal to the top edge, and an axial width of the top mount longitudinally parallel the substantially flat, sloping portion of the top edge.

Still another exemplary, non-limiting optional aspect of the present invention provides a device, further comprising:

a top mount brace for supporting a combined weight carried by the top mount, including the weapon and the lock mechanism.

Yet another exemplary, non-limiting optional aspect of the present invention provides a device, wherein:

the lock mechanism is coupled with the main frame.

A further exemplary, non-limiting optional aspect of the present invention provides a device, wherein:

the lock mechanism is coupled with an underside of the top mount at a distal end thereof, away from the vertical portion.

Still a further exemplary, non-limiting optional aspect of the present invention provides a device, wherein:

the lock mechanism is coupled with the vertical portion.

Yet a further exemplary, non-limiting optional aspect of the present invention provides a device, wherein:

the lock mechanism is coupled with the base.

Another exemplary, non-limiting optional aspect of the present invention provides a device, wherein:

the safety-lock module is configured to block and prevent removal or loading of the weapon.

Still another exemplary, non-limiting optional aspect of the present invention provides a device, wherein:

the safety-lock module is configured to block and prevent removal and loading of the weapon.

Yet another exemplary, non-limiting optional aspect of the present invention provides a device, wherein:

the safety-lock module is comprised of:
a first section configured to prevent an actuation of a loading mechanism of the locked weapon; and
a second section configured to prevent the removal of the locked weapon from the lock mechanism.

A further exemplary, non-limiting optional aspect of the present invention provides a device, wherein:

the main frame is further comprised of:

an alignment support.

Still a further exemplary, non-limiting optional aspect of the present invention provides a device, wherein:

the external support is mounted on a lower portion of a frame of a motorcycle, with the external support comprised of:

a support bar and a support bracket.

Yet a further exemplary, non-limiting optional aspect of the present invention provides a device, wherein:
the external support is mounted on a lower portion of a frame of a motorcycle, near an exhaust of the motorcycle, with the external support comprised of:
a support bar along an axial length of the external support;
a support bracket along an axial width of the external support that is coupled along a transverse length of the support bar.

Another exemplary, non-limiting optional aspect of the present invention provides a device, wherein:
the support bar is comprised of:
a bar length that defines the axial length of the external support;
a bar thickness that defines the transverse length of the support bar;
a bar height that progressively decreases longitudinally along the axial length of the external support from a connecting end of the support bar, with the connected end defining a bar connecting aperture oriented transverse the axial length of the support bar.

Still another exemplary, non-limiting optional aspect of the present invention provides a device, wherein:
the support bar is comprised of:
a bar length that defines the axial length of the external support;
a bar thickness that defines the transverse length of the support bar, and a bar height longitudinally along the axial length of the external support from a connecting end of the support bar, with the connected end defining a bar connecting aperture.

Yet another exemplary, non-limiting optional aspect of the present invention provides a device, wherein:
the support bracket is comprised of:
a bracket length that defines the axial width of the external support;
a bracket center section that is attached to the support bar; and
bracket apertures at longitudinal distal ends of the support bracket that are used to connect an bottom of the hard casing to external support using a set of fasteners.

A further exemplary, non-limiting optional aspect of the present invention provides a device, wherein:
the bracket apertures are used to connect an exterior bottom of the hard casing to external support using a set of screws.

Still a further exemplary, non-limiting optional aspect of the present invention provides a device, wherein:
the hard casing is comprised of a first piece that mounts on a motorcycle that is pivotally coupled with a second piece by a hinge mechanism that is positioned longitudinally along an axial length of the hard casing;
the first piece includes a lateral end with an opening to enable a small portion of the weapon to extend out, with the second piece having an auxiliary cover that conceals and protects the extended small portion of the weapon.

Another exemplary, non-limiting optional aspect of the present invention provides a portable device, comprising:

a portable hard casing for carrying a locked and substantially concealed weapon;

a rack lock mechanism for securely locking the weapon, with the rack lock mechanism mounted within the portable hard casing to maintain the securely locked weapon substantially concealed, out of view of public, and out of elements.

Another exemplary, non-limiting optional aspect of the present invention provides a device, comprising:

a rack lock safety mechanism for securely locking a weapon, with the rack lock safety mechanism mounted within a stand-alone hard casing to maintain the securely locked weapon substantially concealed, out of view of public, and out of elements.

Another exemplary, non-limiting optional aspect of the present invention provides a rack lock safety mechanism for securely locking a weapon, comprising:

a main frame,

a safety-lock module coupled with the main frame; and

a lock mechanism coupled with the main frame.

Another exemplary, non-limiting optional aspect of the present invention provides a rack lock safety mechanism for securely locking a weapon, wherein:

the main frame is comprised of:

a base having sufficient expanse for stability of the rack lock safety mechanism to withstand various forces;

a stand coupled with the base; and

a brace coupled with the stand for added support.

Still another exemplary, non-limiting optional aspect of the present invention provides a rack lock safety mechanism for securely locking a weapon, wherein:

the safety-lock module is configured to block and prevent removal or loading of the weapon.

Such stated advantages of the invention are only examples and should not be construed as limiting the present invention. These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding part(s) throughout:

FIGS. 1A to 1C are non-limiting, exemplary illustrations of an exemplary weapon mounted onto a rack lock safety mechanism, which, in turn, is mounted within a casing of a law enforcement motorcycle in accordance with the present invention;

FIGS. 1D and 1E are non-limiting, exemplary illustration of the rack lock safety mechanism of FIGS. 1A to 1C mounted within the casing of the law enforcement motorcycle, but with the weapon removed in accordance with the present invention;

FIGS. 2A to 2F are non-limiting exemplary illustrations of details of the hard casing of the law enforcement motorcycle in accordance with the present invention;

FIGS. 3A to 3H are non-limiting exemplary illustrations of the various views of the rack lock safety mechanism in accordance with the present invention;

FIGS. 4A to 4F are non-limiting exemplary illustrations of the various views of the rack lock safety mechanism of FIGS. 1A to 3H onto which a weapon is mounted in accordance with the present invention;

FIGS. 5A to 5E are non-limiting exemplary illustrations of the various views of another embodiment of a rack lock safety mechanism 500 in accordance with the present invention, but without the lock mechanism;

FIGS. 6A to 6C are non-limiting exemplary illustrations of the various views of the rack lock safety mechanism of FIGS. 5A to 5E, including a lock mechanisms mounted thereon in accordance with the present invention;

FIGS. 7A to 7G are non-limiting exemplary illustrations of the various views of the rack lock safety mechanism of FIGS. 5A to 6C, including a weapon mounted thereon in accordance with the present invention; and

FIGS. 8A to 8C are non-limiting exemplary illustrations of the various views of an external support in accordance with the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

The present invention provides a rack lock safety mechanism for securely locking a weapon, comprising a main frame, a safety-lock module coupled with the main frame, and a lock mechanism coupled with the main frame. The main frame is comprised of a base having sufficient expanse (area) for stability of the rack lock safety mechanism to withstand various forces, a vertical portion coupled with the base, and a brace coupled with the vertical portion for added support. The safety-lock module is configured to block and prevent removal of a weapon and loading of the weapon while the weapon is locked within the locking mechanism. It should be noted that the main frame of the rack lock safety mechanism may comprise of a single piece integral unit or, alternatively, it may comprise of several pieces that are interchangeably and securely interlocked with one another or welded into a single integral piece.

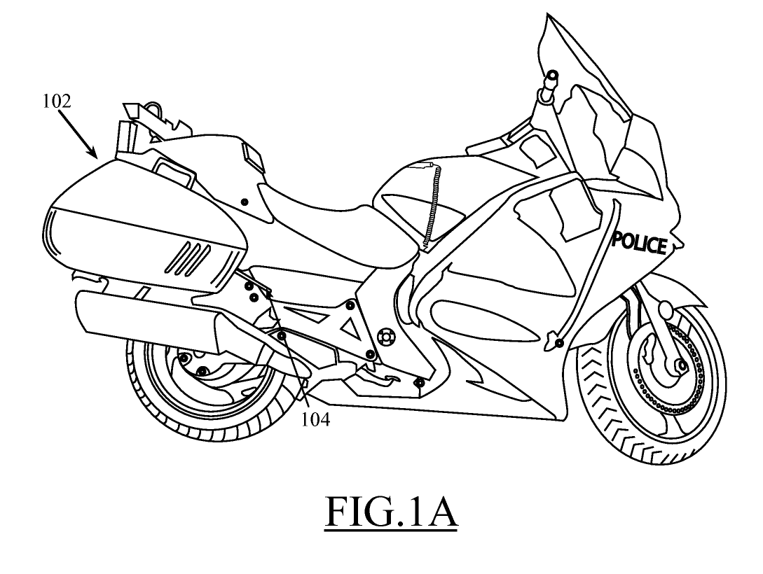

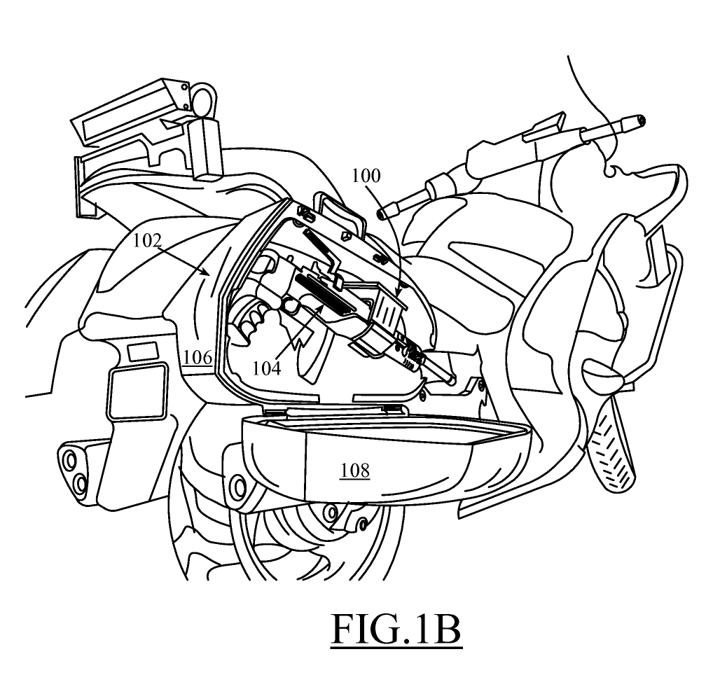

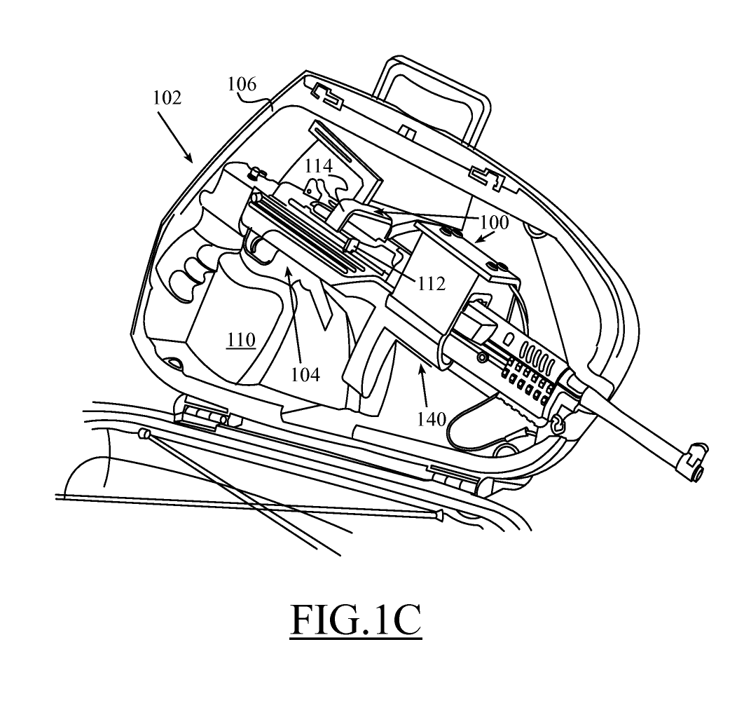

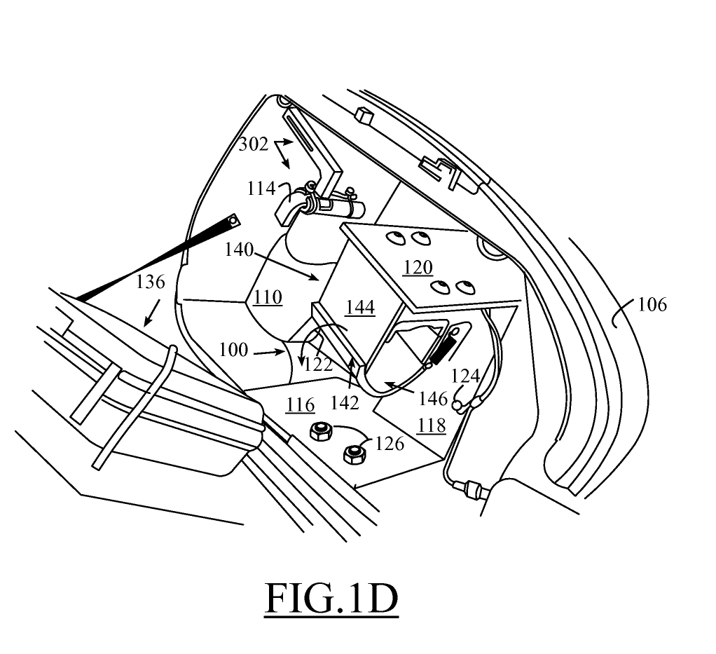

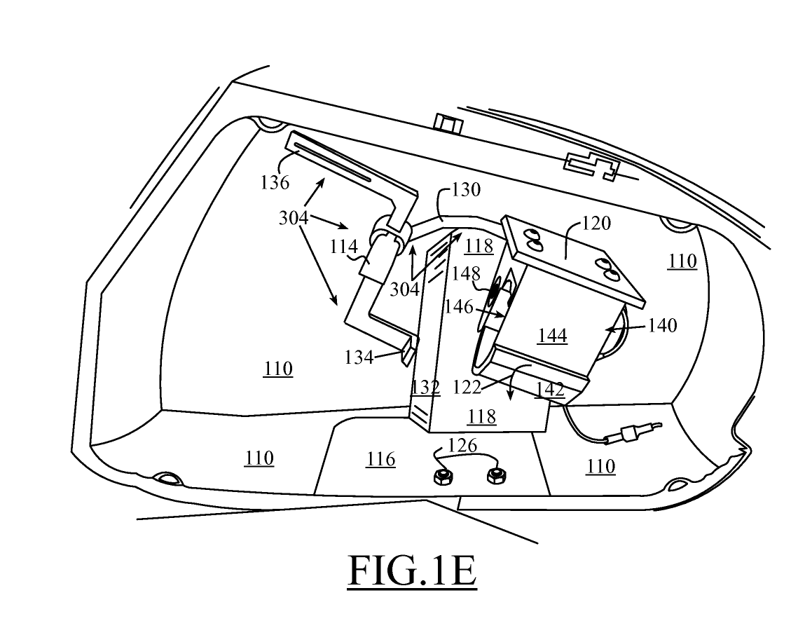

FIGS. 1A to 1C are non-limiting, exemplary illustrations of an exemplary weapon mounted onto a rack lock safety mechanism, which, in turn, is mounted within a casing of a law enforcement motorcycle in accordance with the present invention. FIGS. 1D and 1E are non-limiting, exemplary illustration of the rack lock safety mechanism of FIGS. 1A to 1C mounted within the casing of the law enforcement motorcycle, but with the weapon removed in accordance with the present invention.

As illustrated in FIGS. 1A to 1E, the present invention provides a rack lock safety mechanism 100 for mounting and locking an unloaded rifle 104, with the rack lock safety mechanism 100 itself mounted within a hard casing 102 of a law enforcement motorcycle, keeping the unloaded weapon 104 concealed, out of view the public, and out of the elements.

The present invention uses a conventional hard casing 102 used on conventional law enforcement motorcycles to carry a locked and concealed unloaded weapon 104 using the rack lock safety mechanism 100 of the present invention. The rack lock safety mechanism 100 of the present invention also prevents the loading or reloading of the weapon 104 while the rifle is locked within the rack lock safety mechanism 100 of the present invention. That is, even if a loaded magazine is coupled with the rifle 104, the rounds (e.g., bullet or ammunition) cannot be loaded from the magazine and into the rifle 104 when the rifle (and its magazine coupled thereto) are locked within the rack lock safety mechanism 100 of the present invention. It should be noted that the present invention enables locking of both the rifle 104 and its magazine coupled together, but prevents and blocks the rounds within the coupled magazine from being loaded into the rifle 104 while the rifle 104 and its accompanying magazine are locked onto the rack lock safety mechanism 100 of the present invention.

Accordingly, one embodiment of the present invention is incorporated within a hard casing 102 for carrying a locked and substantially concealed weapon 104 and a rack lock safety mechanism 100 for securely locking the weapon 104, with the rack lock safety mechanism 100 mounted within the hard casing 102 to maintain the securely locked weapon 104 substantially concealed, out of view of public, and out of elements.

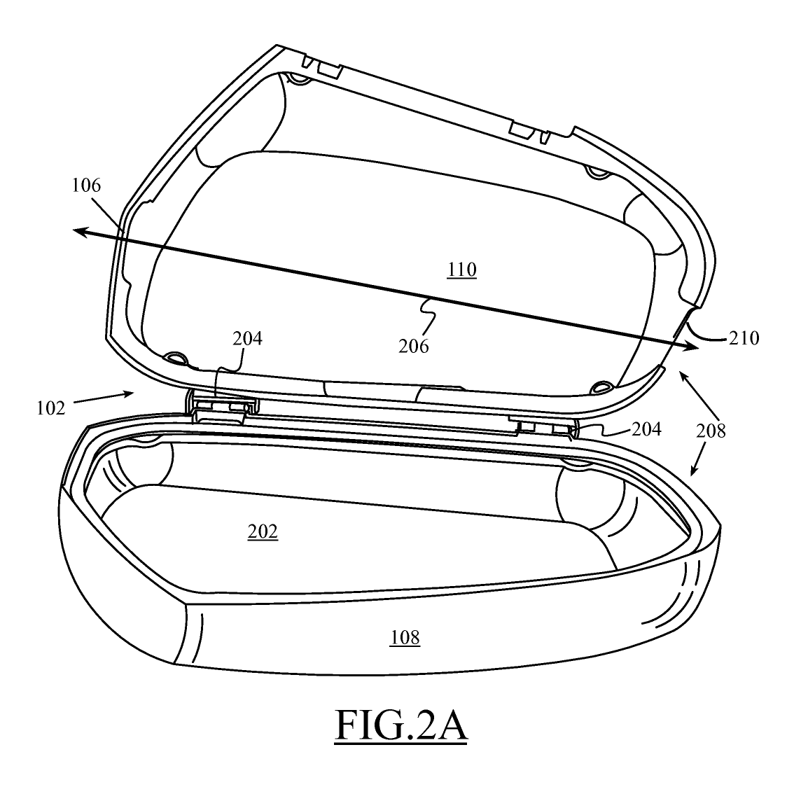

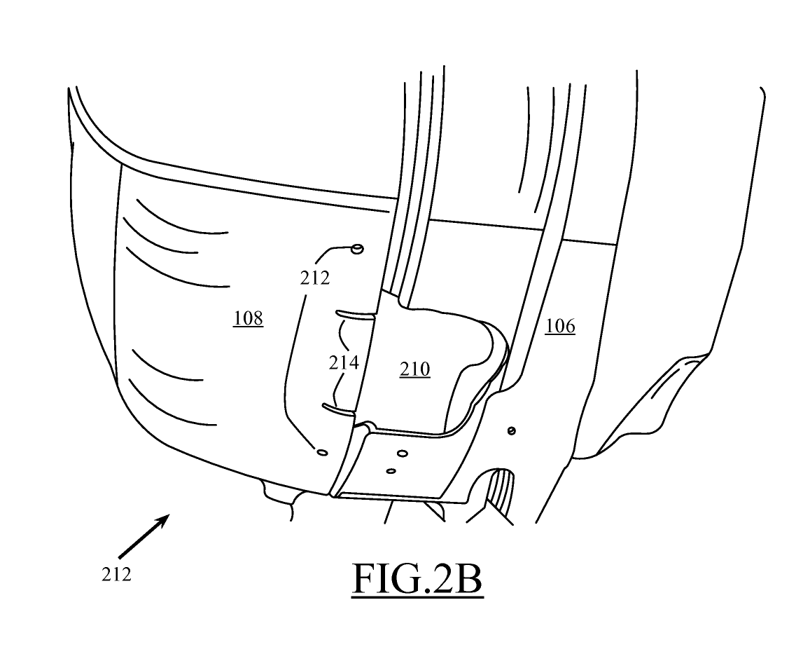

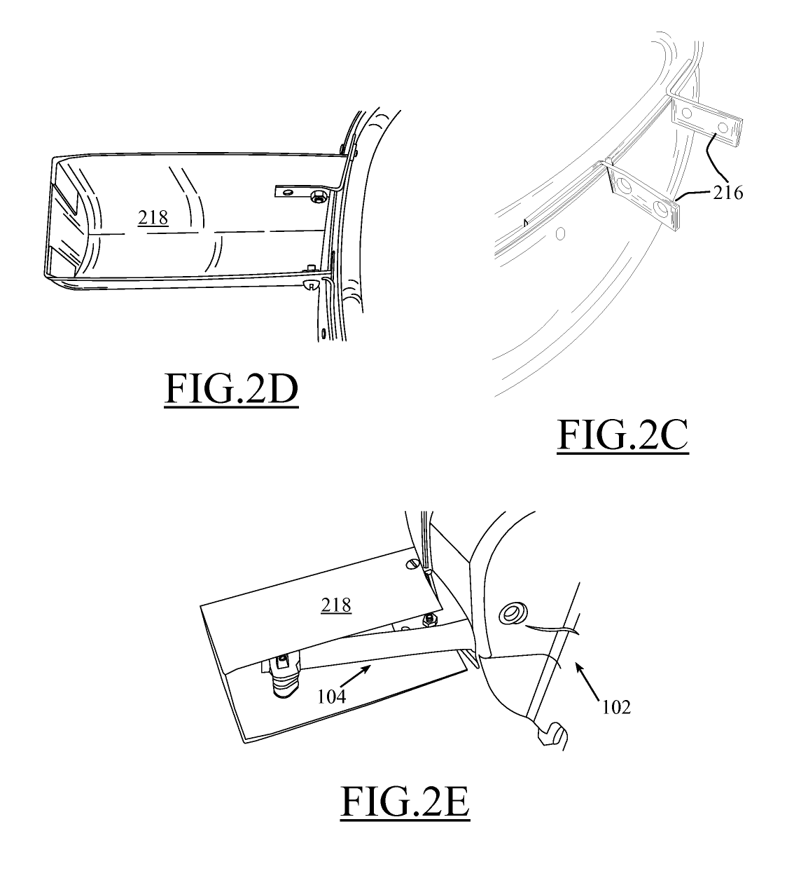

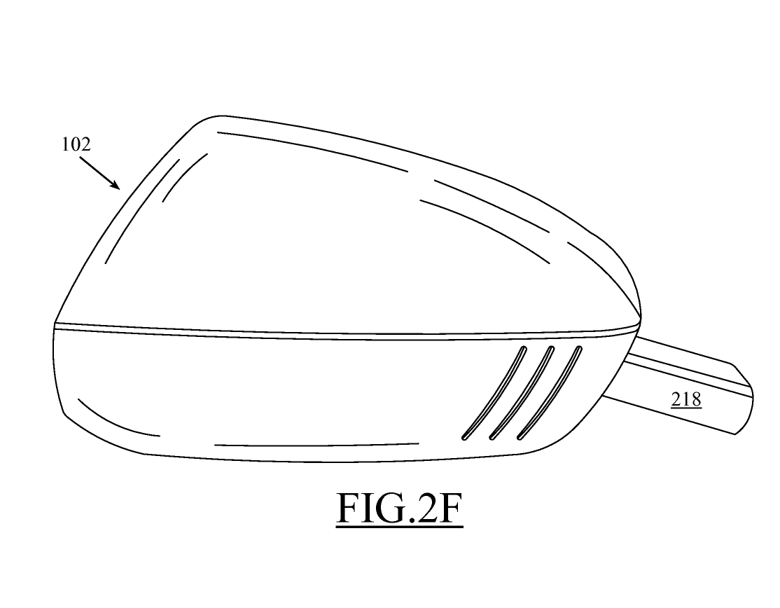

The hard casing 102 is illustrated to have a substantially teardrop configuration comprised of a first piece 106 that mounts on a motorcycle that is pivotally coupled with a second piece 108 by a hinge mechanism 204 (FIG. 2A) that is positioned longitudinally along an axial length 206 of the hard casing 102. The hard casing 102 includes a first lateral end 208 with an opening 210 to enable a small portion of the weapon 104 that is stored therein to extend out from the opening 208.

It should be noted that the configuration of the hard casing 102 should not be limited to a teardrop shape or the way it opens or closes as exemplarily illustrated throughout the figures, and can have any form with different hinge systems. The reason for illustrating an exemplary teardrop shape is because that is a standard issue storage compartment configuration used with most law enforcement motorcycles. Accordingly, any storage compartment that has sufficient space or volume that can securely and safely accommodate the rack lock safety mechanism 100 of the present invention may be used.

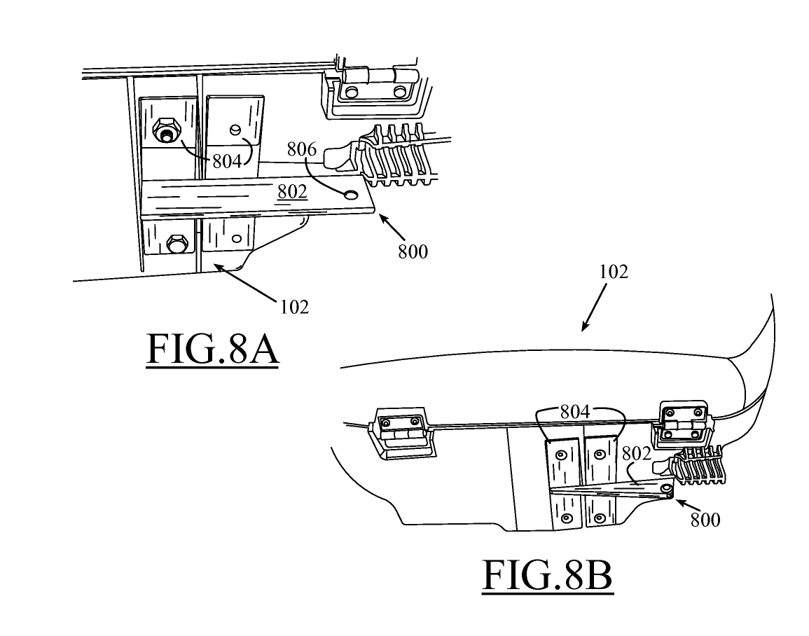

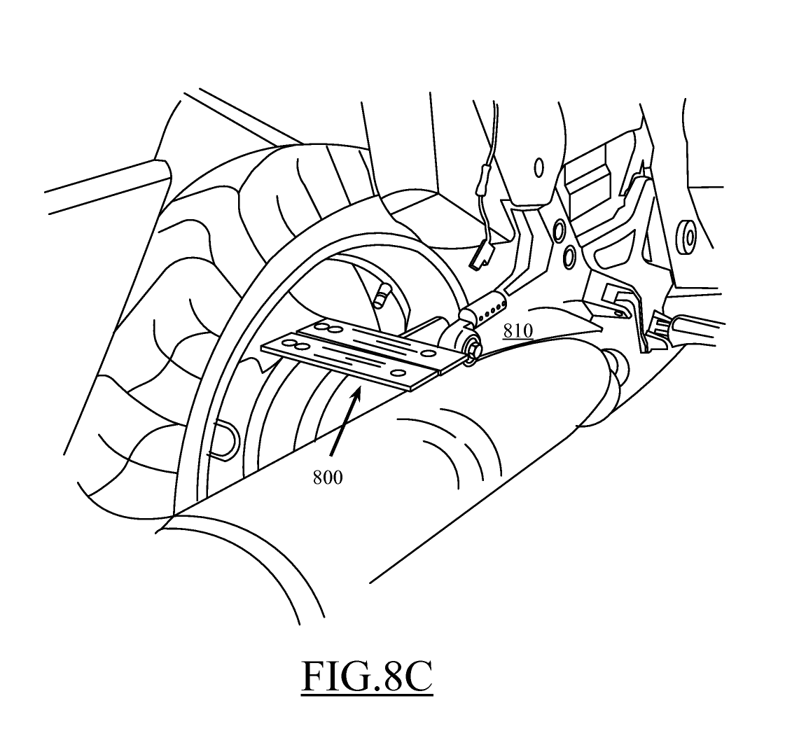

Referring back to FIGS. 1A to 1E, the rack lock safety mechanism 100 is mounted within the first interior 110 of the first piece 106 of the hard casing 102 using fasteners 126, with the hard casing 102 securely mount onto an external support 800 (FIGS. 8A to 8C). As illustrated in FIGS. 1A to 2A, a second interior 202 of the second piece 108 of the hard casing 102 has sufficiency space for storage of other materials 136 (FIG. 1D) that may be carried by law enforcement. Accordingly, the present invention provides a compact and secure rack lock safety mechanism 100 for safely and securely storing and concealing a weapon 104 without taking much space, leaving much room for storage of other materials 136 within a small compartment.

It should be noted that it is preferred if the rack lock safety mechanism 100 is mounted within the hard casing 102 using a same set of fasteners 126 that securely mount the hard casing 102 onto the external support 800 (FIGS. 8A to 8C), with the fasteners 126 extended from the external support 800 and through the hard casing 102, enabling locking and secure mounting of the rack lock safety mechanism 100 together within the hard casing 102 and onto the external support 800.

FIGS. 2A to 2F are non-limiting exemplary illustrations of details of the hard casing of the law enforcement motorcycle in accordance with the present invention. As stated above, the hard casing 102 is comprised of the first piece 106 that mounts on the motorcycle (via the external support 800) that is pivotally coupled with the second piece 108 by the hinge mechanism 204 that is positioned longitudinally along an axial length 206 of the hard casing 102. The first piece 106 (at the lateral end 208 of the casing 102) includes the opening 210 to enable a small portion of the weapon 104 to extend out, with the second piece 108 having an auxiliary cover 218 that conceals and protects the extended small portion of the weapon 104.

As best illustrated in FIGS. 2B to 2E, the second piece 108 (at the lateral end 208 of the hard casing 102) includes a set of apertures 212 and slits 214 for inserting and fastening a set of anchors 216 to mount the cover 218 onto the second piece 108 (at the lateral end 208 of hard casing 102). It should be noted that the entire second piece 108 of the hard casing 102 (including the cover 218) may be comprised of a single integral piece that is molded and then coupled with the first piece 106. Accordingly, the cover 218 need not be a separate, add-on piece, and can be pre-fabricated (e.g., molded) with the second piece 108 as a single integral second piece 108 to be coupled with the first piece 106. Further, the lateral end 208 of the hard casing 102 need not be modified in accordance with the present invention if the rifle 104 has shorter span than the longitudinal axis 206 of the hard casing 102 or, alternatively, the hard casing 102 itself is made longer.

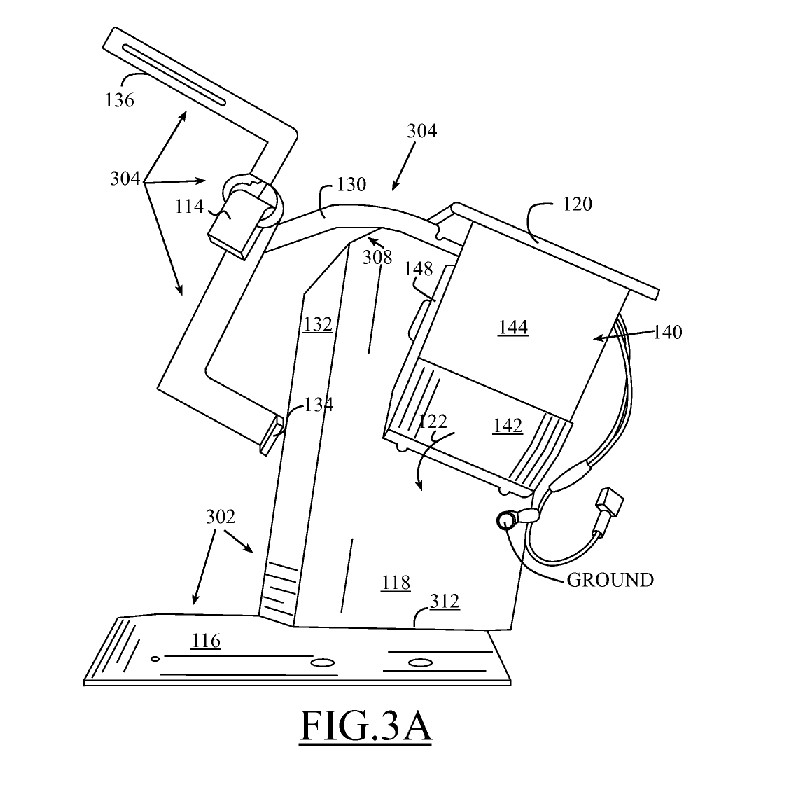

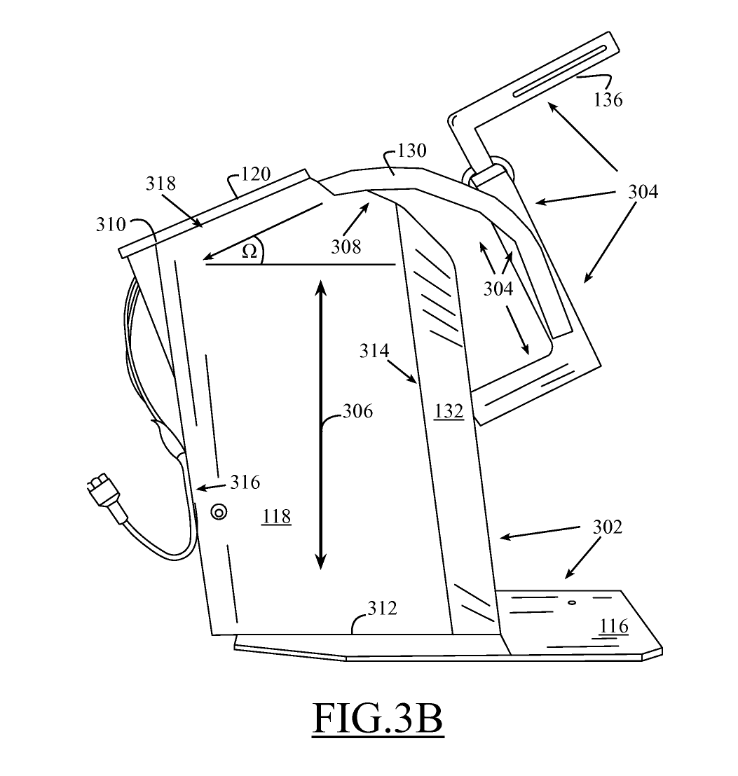

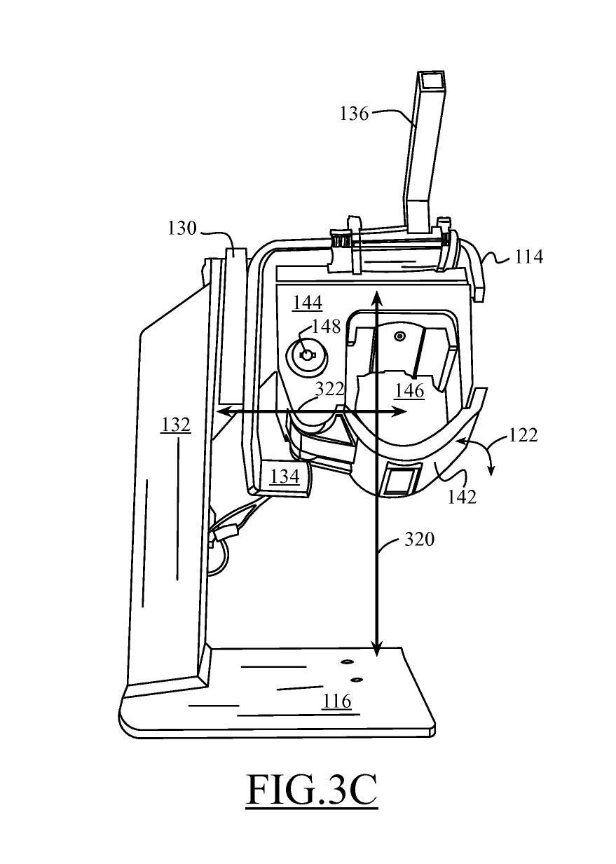

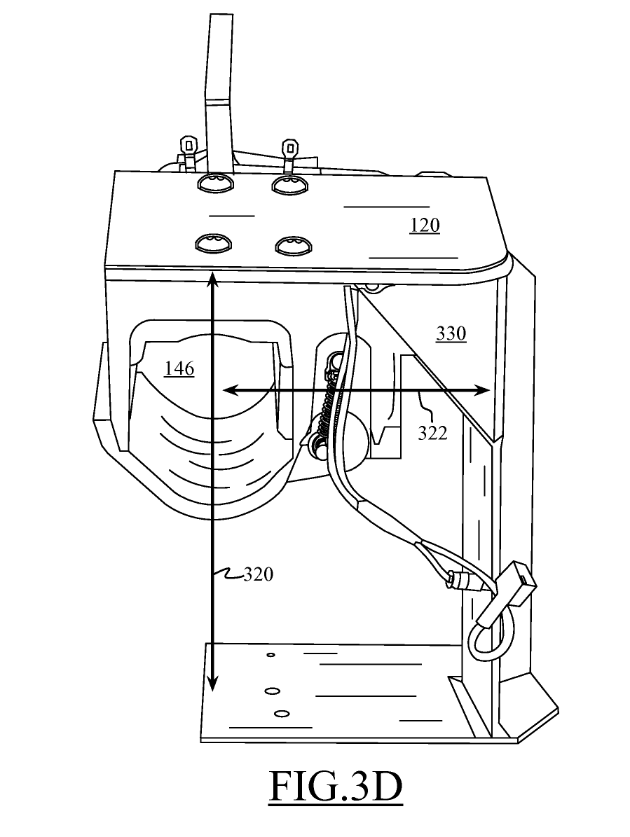

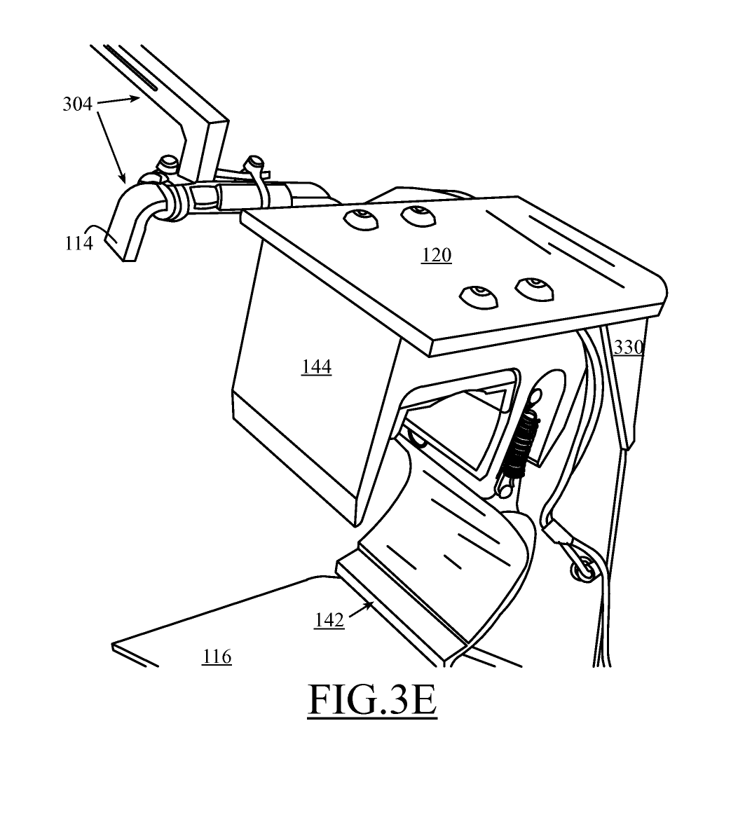

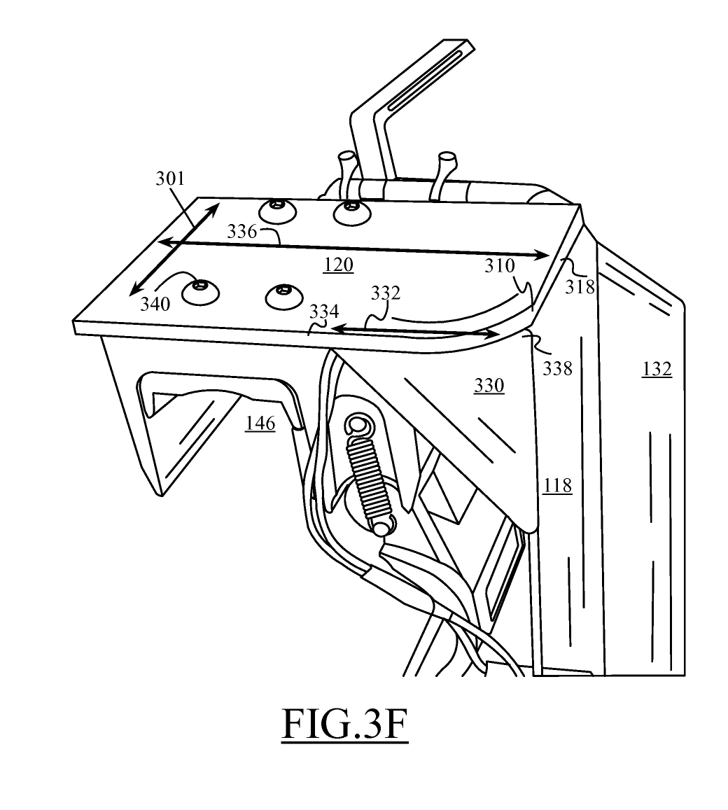

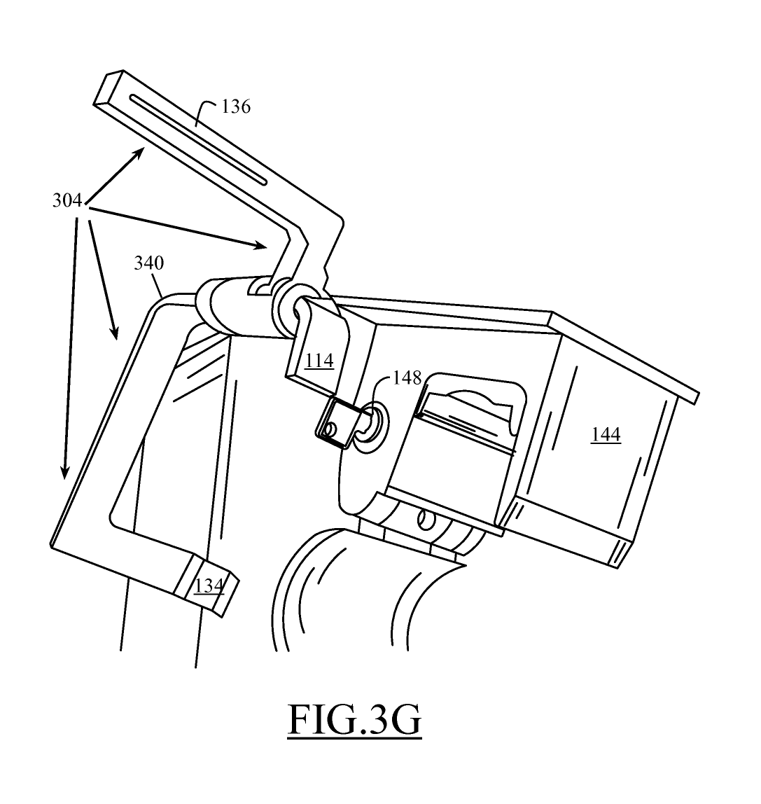

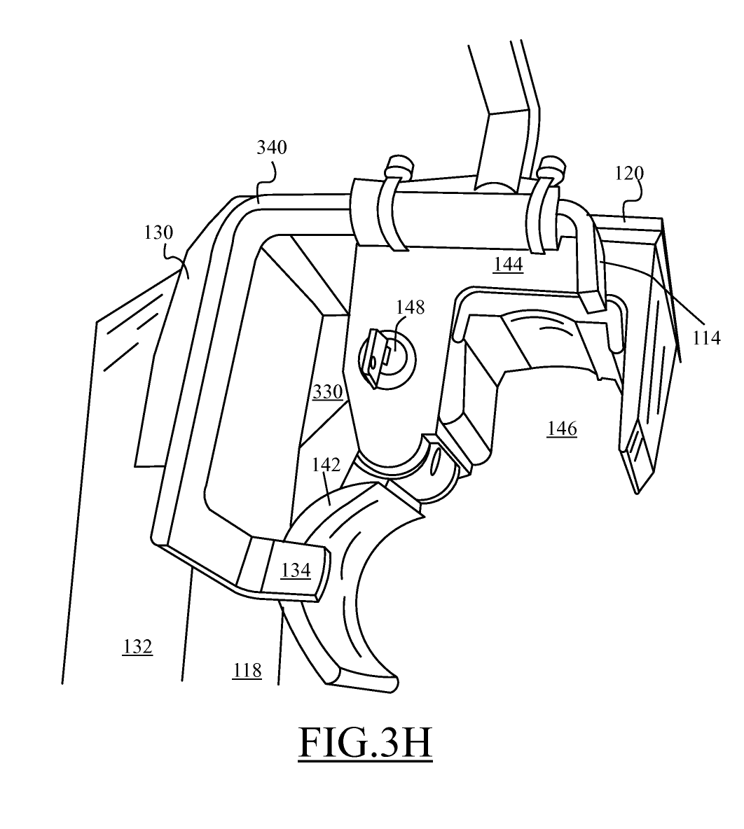

FIGS. 3A to 3H are non-limiting exemplary illustrations of the various views of the rack lock safety mechanism in accordance with the present invention. The rack lock safety mechanism 100 is comprised of a main frame 302, a safety-lock module 304, and a well-known lock mechanism 140. A non-limiting example of a lock mechanism 140 used with the present invention may include a Santa Cruz 12 Volt operated latching system, which can be opened by a hidden toggle switch. The lock mechanism 140 is comprised of a first static piece 144 coupled with the main frame 302, and a second moving (or locking) piece 142 that moves along the reciprocating path 122 to an open position to enable insertion or removal of the weapon 104. The second piece 142 locks with the first piece 144 in the closed positioned by a key lock 148, with the weapon locked in the cylindrically hollow locking chamber 146.

The main frame 302 is comprised of a base 116 with a base-width and a base-length providing sufficient base-span for stability of the rack lock safety mechanism 100 to withstand externally or internally applied forces such as torque or vibration forces from the motion of the motorcycle (to which the hard casing 102 is coupled) that may move the rack lock safety mechanism 100 in relation to the hard casing 102 onto which it is mounted. The base 116 has a base-perimeter configured commensurate with accommodations provided by an interior bottom of the hard casing 102. Accordingly, the base 116 designs may vary commensurate with the interior of the hard casing 102 for an appropriate fit.

The main frame 302 is further comprised of a stand 118 coupled with the base 116, with the stand 118 supporting a weight of the lock mechanism 140 and the weapon 104 at an elevation from the base 116. A length of the main vertical portion of the rack lock safety mechanism 100 defines the height 306 of the stand 118. It should be noted that the height at which the lock mechanism 140 is elevated along the stand 118 from the base 116 depends on the configuration of the lock mechanism 140, and should not be limiting. In this non-limiting exemplary instance, the lock mechanism 140 has the second moving section 142 that opens along a reciprocating path 122, which would require sufficient clearing from the base 116 to open sufficiently wide to enable comfortable, easy insertion or removal of the weapon 104. Accordingly, if another type of lock mechanism 140 is used (or if the lock mechanism 140 is mounted onto the vertical portion upside-down (the portion 142 opens upward, opposite the path 122)) where the insertion or removal of a weapon 104 would not require clearing of any portion of the lock mechanism 140 from the base 116, then the lock mechanism 140 need not be elevated along the height of the stand 118 from the base 116. Lowering the lock mechanism 140 would also be beneficial in that it would lower the overall center of gravity of the present invention. In general, the stand 118 may be coupled substantially perpendicular with the base 116.

As further illustrated, the stand 118 is comprised of a first (or bottom or lower) side 312 coupled with the base 116, lateral sides 314 and 316, and a top or upper side 318. It should be noted that the stand 118 may comprise of one or more first bars or rods of sufficient size (width, height, length, thickness, etc.) coupled with the base 116 that would enable secure coupling of the lock mechanism 140 and withstand external and internal forces (e.g., due to vibrations). One may also optionally couple the first bars or rods with one another by one more second substantially transverse bars or rods, which would provide added structural strength for added structural integrity.

The top edge or side 318 of the stand 118 is comprised of an arced bend defining a first corner 308 between the top side 318 and the first lateral side 314, a sustainably flat, sloping portion (sloping at an angle Ω), and a second corner 310 between the top side 318 and the second lateral side 316, with the second corner 310 positioned at a lower height from the first corner 308 to thereby form a top side 318 that is slanted at a slope from the first corner 308 to the second corner 310.

The configuration of the stand 118 that defines the height of the rack lock safety mechanism 100 is commensurate with the shape of the hard casing 102 that accommodates the rack lock safety mechanism 102. In this exemplary instance, the hard casing 102 used has a teardrop shape and therefore, the top edge or side of the stand 118 is sloped to enable the hard casing 102 to accommodate and house the rack lock safety mechanism 100. Accordingly, the silhouette of the stand 118 can vary commensurate with the configuration of the hard casing 102 that will accommodate the rack lock safety mechanism 100.

The main frame 302 is further comprised of a brace 132 for added support for added structural integrity for the stand 118, providing added strength to prevent the stand 118 from being bent. As described, the stand 118 supports the weights of the lock mechanism 140 and the weapon 104 suspended at some elevation 320 above the base 116, with the weapon 104 suspended at some (horizontal) distance 322 away from the stand 118. The combined weight (of the lock mechanism 140 and the weapon 104) at the distances 320 and 322 may flex the stand 118 (especially due to vibration), which in turn, will cause the lock mechanism 140 and the coupled weapon 104 to vibrate. The brace 132 provides an added strength to prevent vibration of the weapon 104 by shoring up or propping up the stand 118.

In other words, the stand 118 must not only withstand the vertical force due to the weight of the pull of the lock mechanism 140 and the weapon 104, with the vertical force being perpendicular (vertically oriented) to the base 116, but also the torque as a result of the distance 322. That is, in addition to the actual load (vertical force) experienced by the stand 118, additional torque is also experienced that can cause rotation or twisting of the stand 118. That is, since the load (the weight of the lock mechanism 140 and the weapon 104) are positioned at a distance 322 away from the stand 118, when a force is applied (their weight), a torque (e.g., rotation or twisting) is also experienced at the top of the stand 118, known as bending moments. That is, a simple, well-known, textbook definition of a torque is that it is a measure of how much a force (e.g., a weight of the lock mechanism 140 plus the weapon 104 are pulling down on the vertical portion) acting on an object (e.g., the stand 118) causes that object (e.g., the stand 118) to rotate. The mount by which the torque is increased is related to the distance 322. This distance 322 functions as the moment arm of the torque. Accordingly, the brace 132 of the present invention is provided to add stability to the stand 118 by countering the vertical force and the torque, preventing the stand 118 from twisting and provides a more secure attachment of the lock mechanism 140 and the weapon 104 with the stand 118.

As illustrated, the brace 132 has a first end coupled with a side 314 of the stand 118, and a second end coupled with the base 116. The brace 132 is illustrated to comprise of a substantially quadrilateral configuration coupled with the base 116 at a first-side, and coupled with the stand 118 at a second-side, with the third and forth sides of the brace 132 being free. It should be noted that the brace 132 may comprise of other types of support structures, non-limiting examples of which may include one or more bars or rods (straight or curved, with one end of the bar or rod coupled with the stand 118 and the other to the base 116). Alternatively, the brace 132 may be comprised of a three-sided (or any polygonal) configuration coupled with the base 116 at a first-side, and coupled with the stand 118 at a second-side, with the third side free.

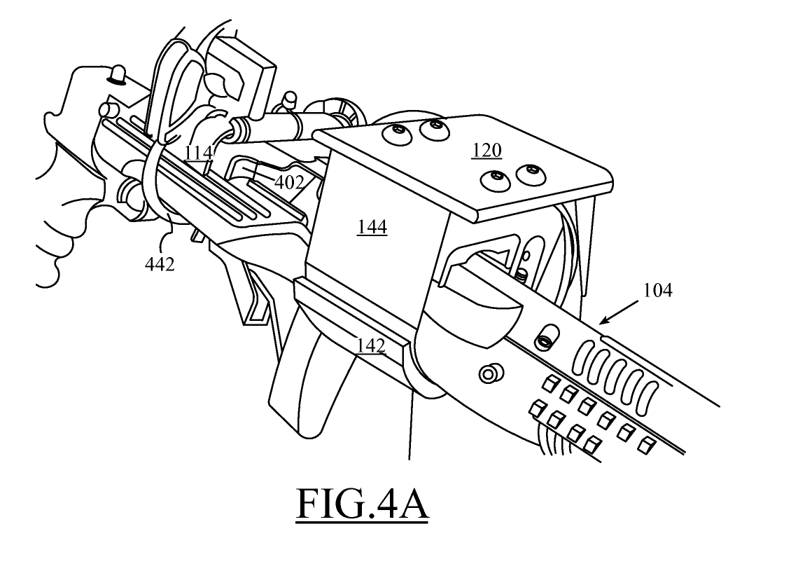

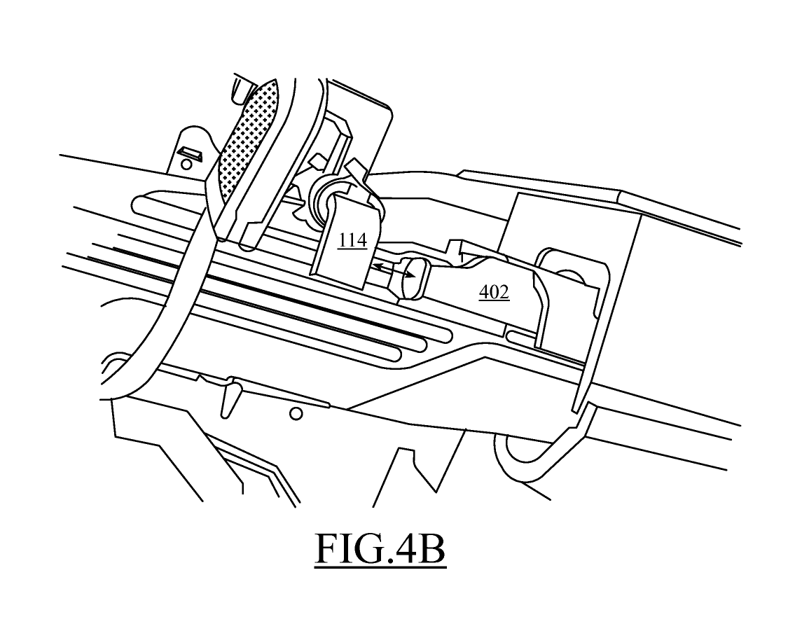

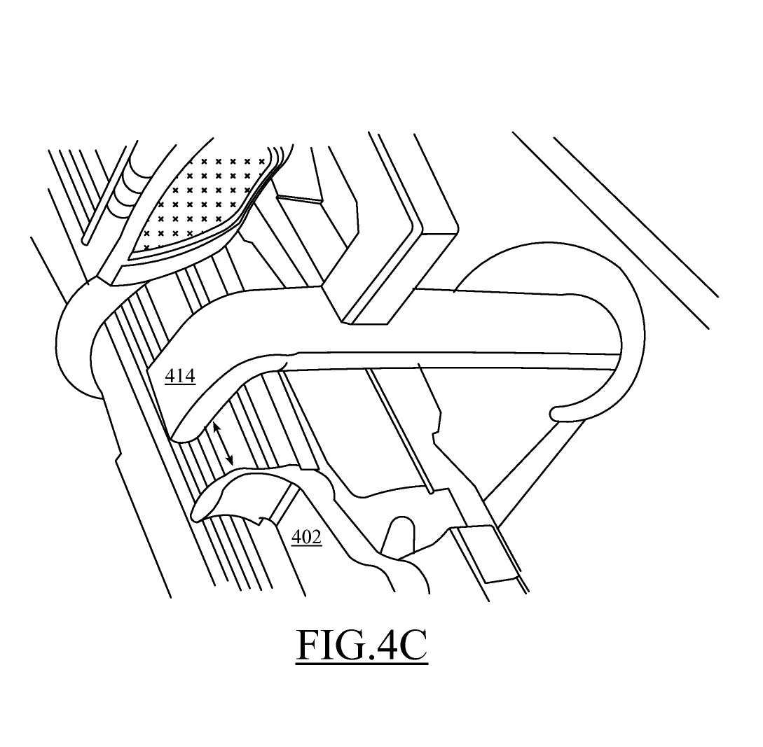

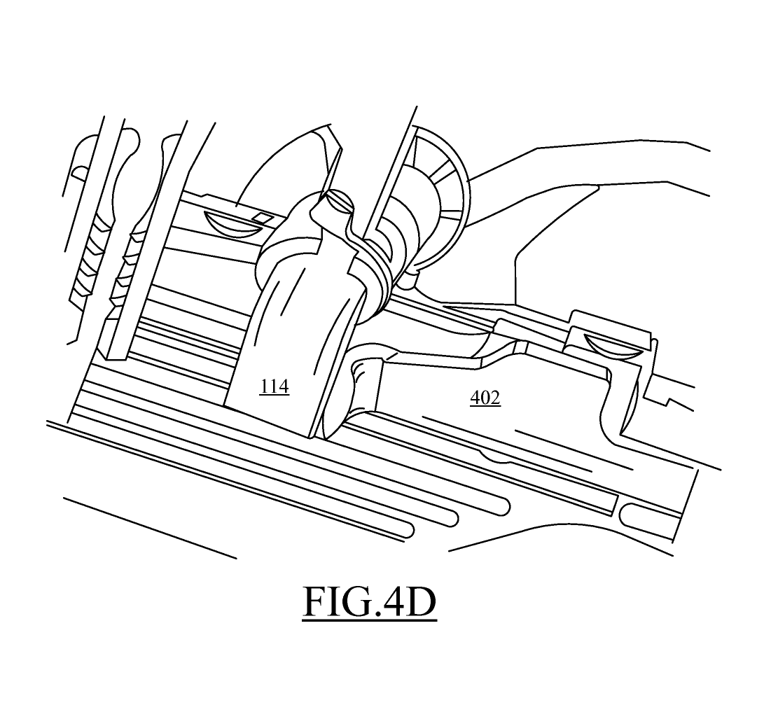

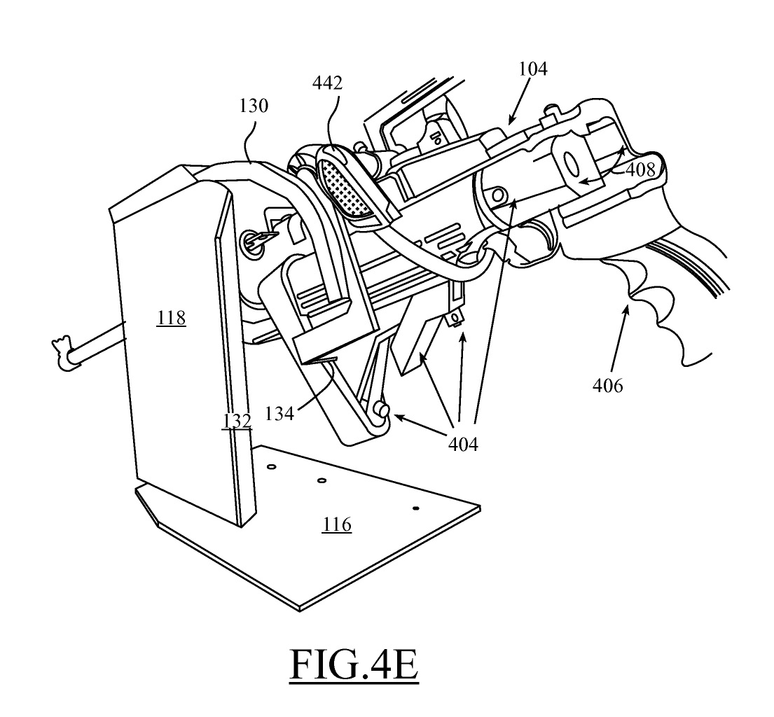

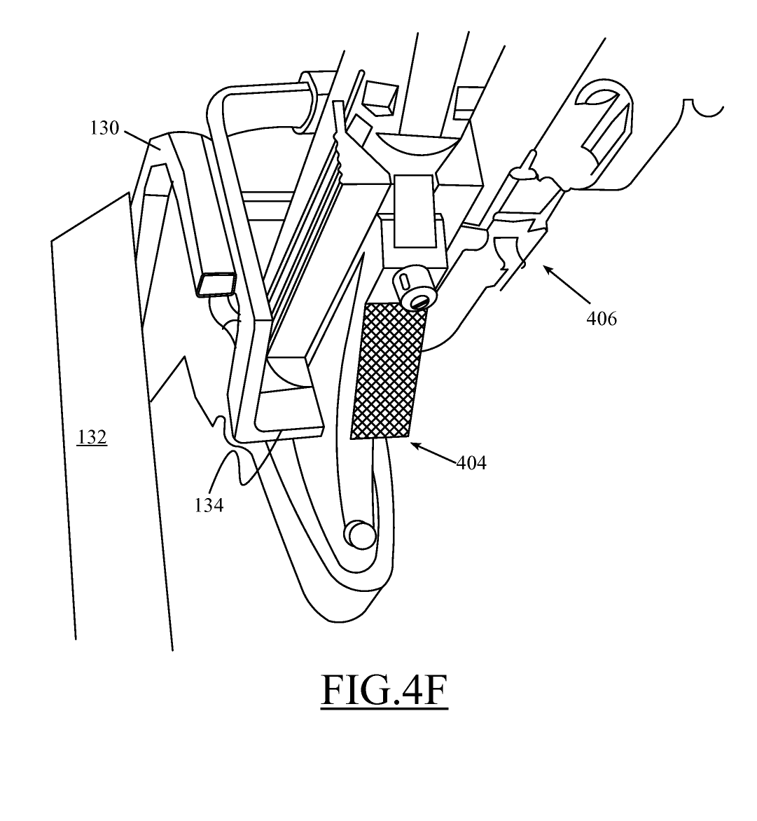

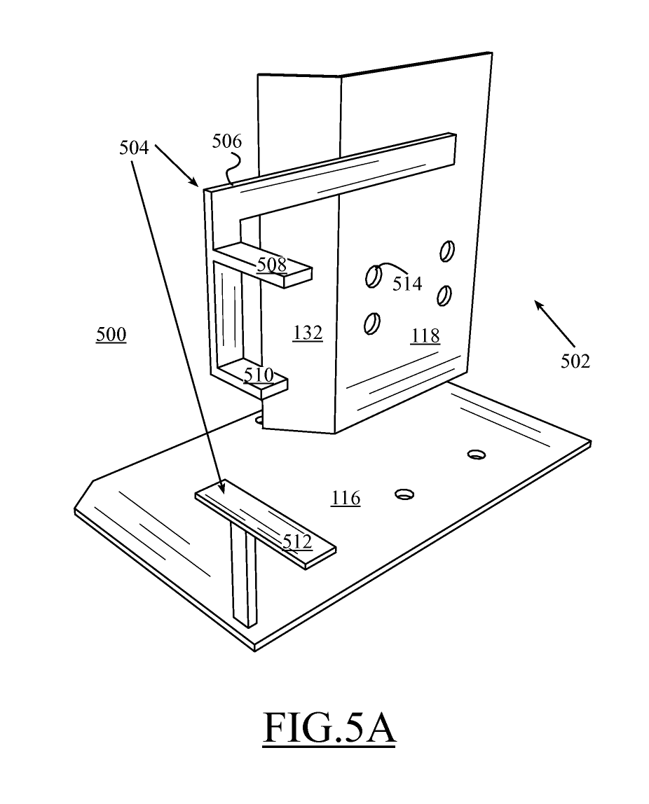

As further illustrated, the main frame 302 is further comprised of an optional top mount 120 that enables the mounting of the lock mechanism 140 there-under. The lock mechanism 140 is coupled with an underside of the top mount 120 at a distal end thereof, away from the stand 118. The top mount 120 is optional because it enables the weapon 104 to be locked within the lock mechanism 140 right side up, as illustrated in FIGS. 4A to 4G. In other words, the lock mechanism 140 may easily and directly be coupled with the stand 118 (as detailed below). The top mount 120 has dimensions commensurate with size and type of lock mechanism 140 mounted there-under. The top mount 120 is connected to the substantially flat, sloping portion of the top edge or side 318 of the stand 118 and is cantilevered, with an axial length 136 of the top mount 120 extended substantially transverse, substantially perpendicular to the top side 318, and an axial width 301 of the top mount 120 longitudinally parallel the substantially flat, sloping portion of the top edge 318.

Also included is a top mount brace 330 that supports the weight carried by the top mount 120. The top mount brace 330 is a polygon of a substantially triangular configuration that is connected between the second corner 310 of the top edge 318 and a lateral top mount side 334 along the axial width 336 of the top mount 120, with a vertex 338 that is shared by the second corner 310. As further illustrated, the lock mechanism 140 is connected to an underside of the top mount 120 at a distal end thereof, a distance 332 away from the stand 118 by a set of fasteners 340. The top mount brace 330 is for supporting a combined weight carried by the top mount 120, including the weapon 104 and the lock mechanism 140. It should be noted that the top mount brace 330 may also be comprised of a bar or rod, with one end coupled to the under-side of the top mount 120 and the other to the stand 118.

As further illustrated in FIGS. 3A to 3H, the rack lock safety mechanism 100 is further comprised of a safety-lock module 304. The safety lock module 304 is configured commensurate with the type, make, and model of a weapon used. In addition, the safety lock module 304 may be fabricated to detachably secure and interlock with the rack lock safety mechanism 100. This way, different types of safety lock module 304 may be manufactured for different types of weapons and used with the same main frame 302. In other words, the safety lock modules 304 can be detached and interchanged with other types or configuration safety lock modules for securing different type, make and model weapons with the same main frame 302. The illustrated safely lock module 304 is a non-limiting example of one specific configuration that may be used for the exemplarily illustrated weapon 104, which is a Ruger ranch-style rifle with a Ruger folding stoke. Therefore, the safety lock module 304 design (as detailed below) can vary commensurate with the specific type of rifle used, and if made detachable, can be removed, interchanged with another safety lock module that is designed for a different type of rifle, and interlocked with the main frame 302.

FIGS. 4A to 4F are non-limiting exemplary illustrations of the various views of the rack lock safety mechanism of FIGS. 1A to 3H onto which a weapon is mounted in accordance with the present invention. As illustrated in FIGS. 1A to 1F and 4A to 4F, the top mount 120 enables the coupling of the lock mechanism 140 with the main frame 302 with orientation so that the combination allows the weapon 104 to be securely locked right side up. As best illustrated in FIGS. 3A to 4F, the exemplarily illustrated safety lock module 304 is comprised of a safety lock bar 340 with flanges 114, 134, and 136 that is configured to block and prevent removal and loading of the weapon 104, and a safety lock connector 130 that is coupled with the safety lock bar 340 and the frame 302. It should be noted that the illustrated configuration of the safety lock bar 340 is commensurate with the specific weapon 104 used and therefore, the illustrated shape is a mere example and may vary depending on the type and model of weapon 104 used, and should not be limiting.

As best illustrated in FIGS. 4A to 4D, the safety lock bar 340 is comprised of a first lock section 114 configured to prevent an actuation of a loading mechanism 402 of the locked weapon 104. The first lock section 114 is shaped over the rifle and blocks the sliding bolt (lock mechanism 402) into its locked in closed position. The first lock section 114 is at a first distal end of the safety lock bar 340. As further illustrated in FIGS. 4E and 4F, the safety lock bar 340 further includes a second lock section 134 configured to prevent the removal of the locked weapon 104 from the lock mechanism 140. This second lock section 134 is shaped to fit against the rear folding stock section (butt) 404 to hold it in place, with front stock 404 secured within hollow locking chamber 146 of the lock mechanism 140. The second lock section 134 is at a second distal end of the safety lock bar 340. Finally, the present invention provides an optional tie-down connector 136 for a tie down strap 442 in a form of an exemplary bungee-cord that is used to prevent a vertical movement (or vibration) of the weapon 104 while in locked position.

As illustrated throughout FIGS. 1A to 4E, the safety lock connector 130 of the safety lock module 304 is configured as an arced cantilever that is coupled with the underside of the top mount 120, near the stand 118, and curves and extends away from the top mount 120 toward the base 116, with a lateral side of the safety lock bar 340 connected to a free end of the safety lock connector 130. It should be noted that the safety lock connector 130 may have any configuration and is not limited to the arced shaped illustrated and further, it may be directly connected onto any section of the stand 118 instead of the underside of the top mount 120. In fact, connecting the safety lock connector 130 onto the vertical portion (e.g., at a lower section) and extending it out and upward (opposite of the arced curve shown) will enable the lock mechanism 140 mounted to the underside of the top mount 120 to be moved “inward” towards the stand 118, reducing distance 322. This inward movement of the lock mechanism 140 (and eventually the weapon 104 that will be locked within) will reduce the torsional forces of the weapon 104 and the lock mechanism 140, improving balance during high-speed rides.

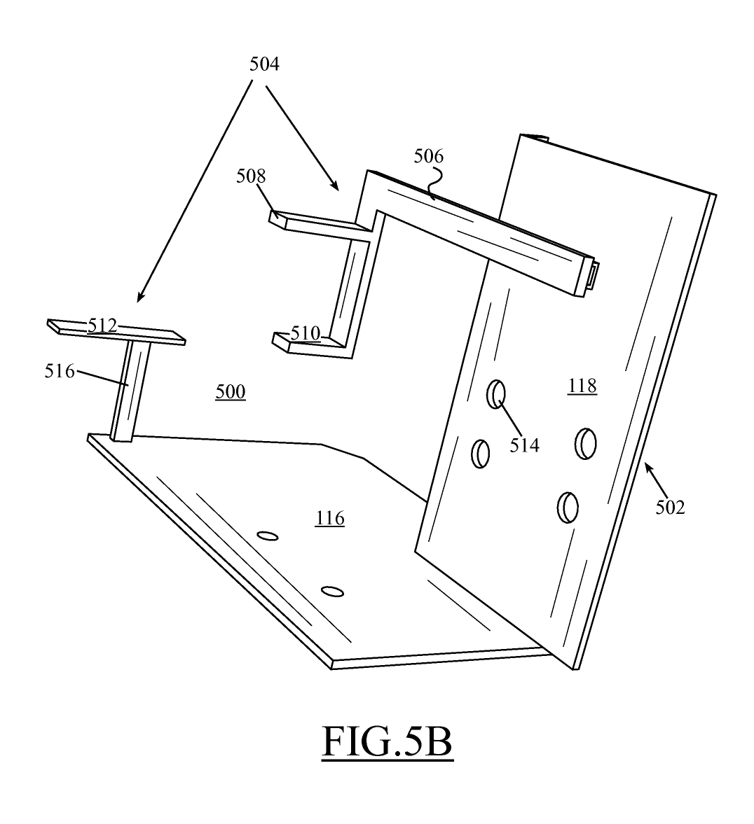

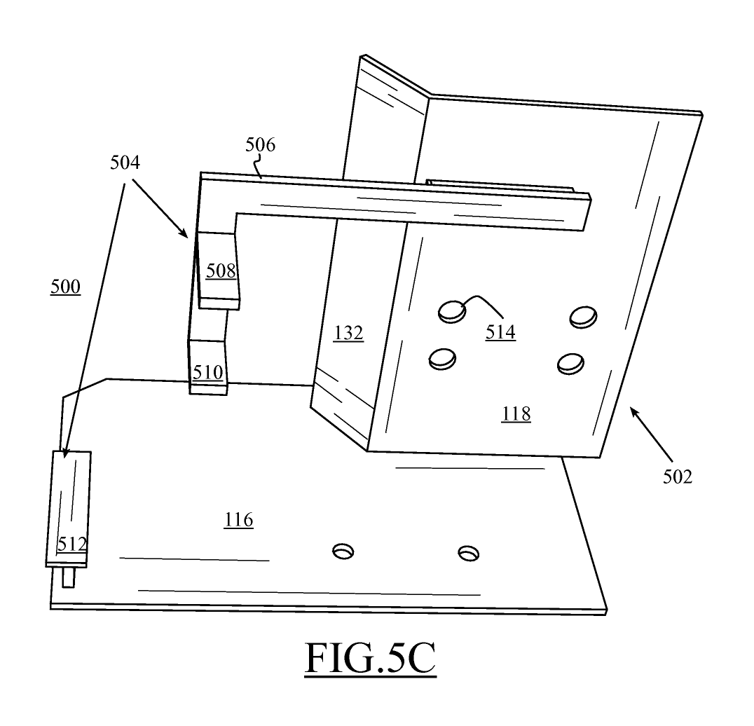

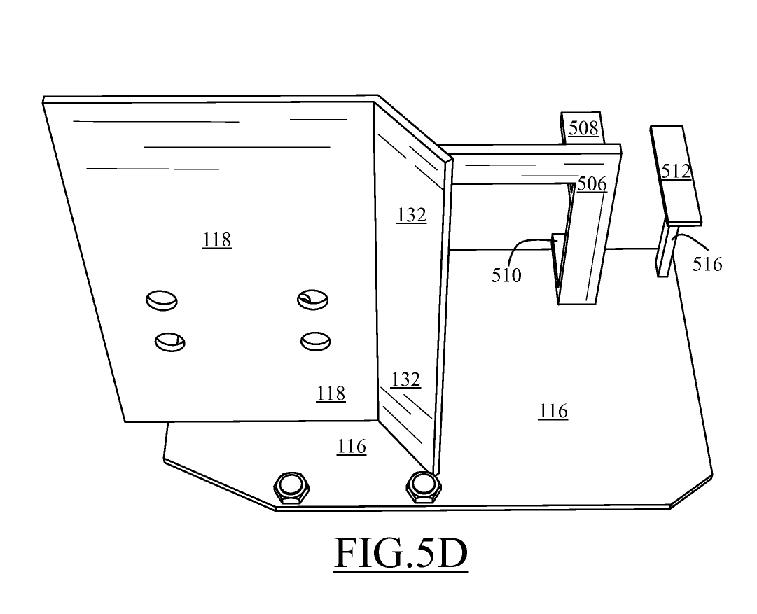

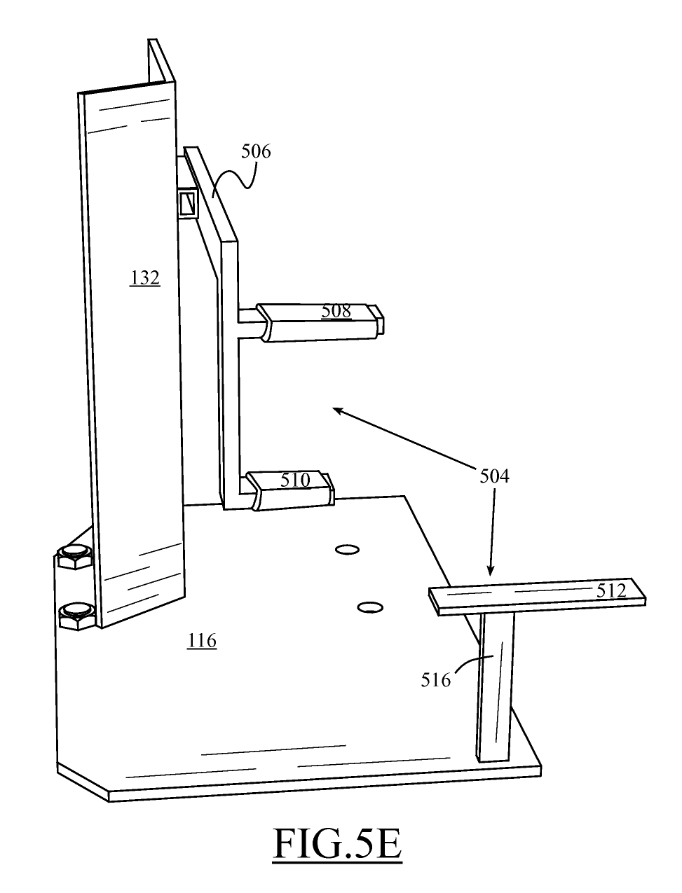

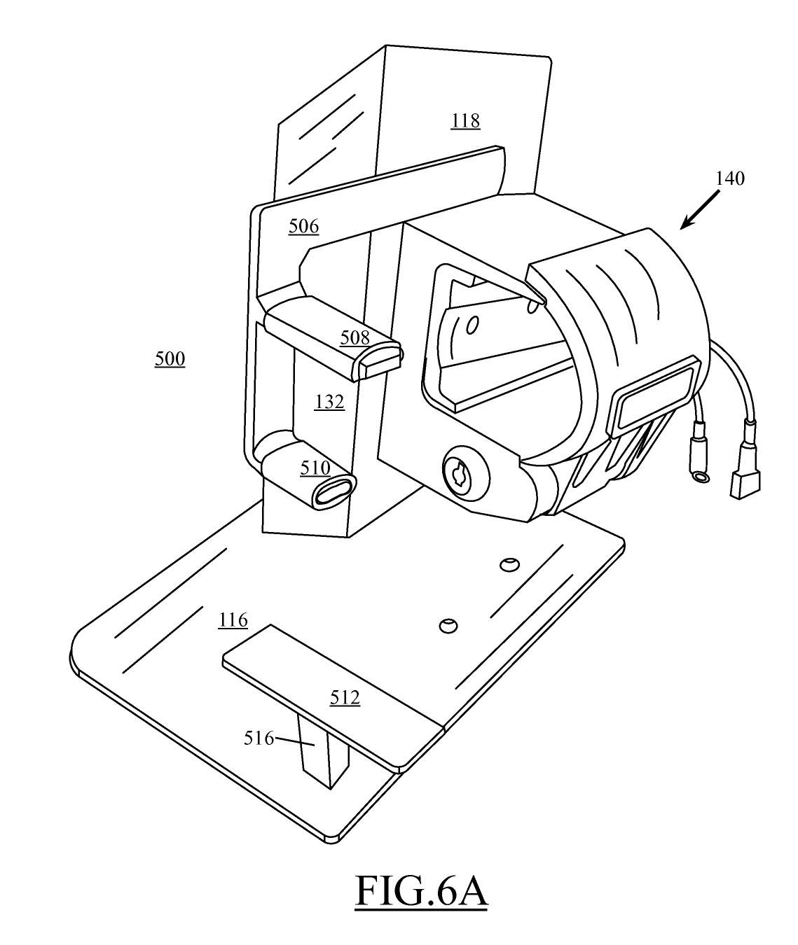

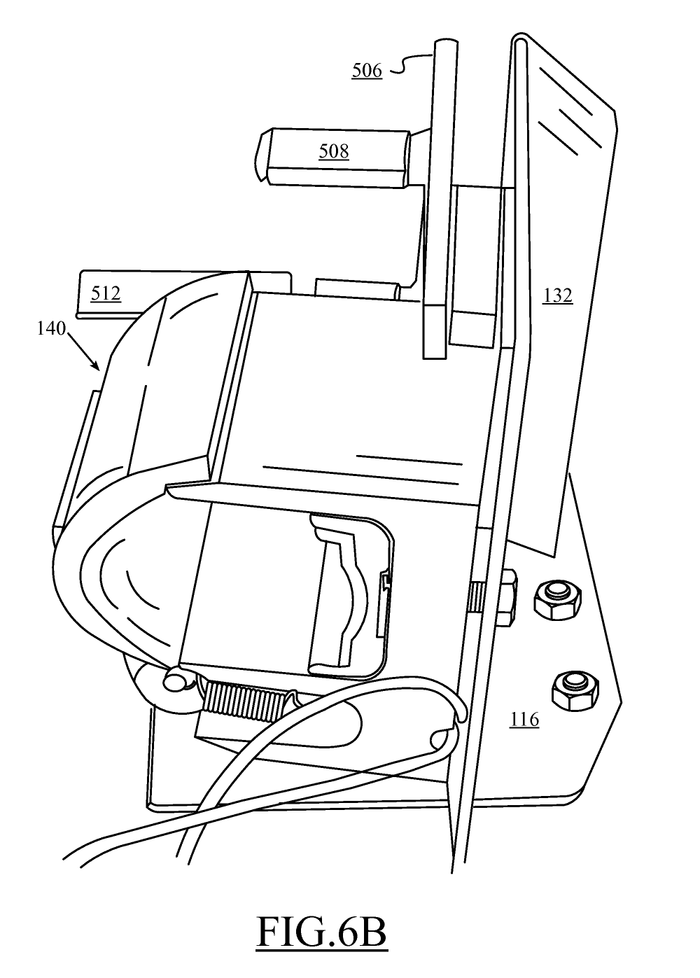

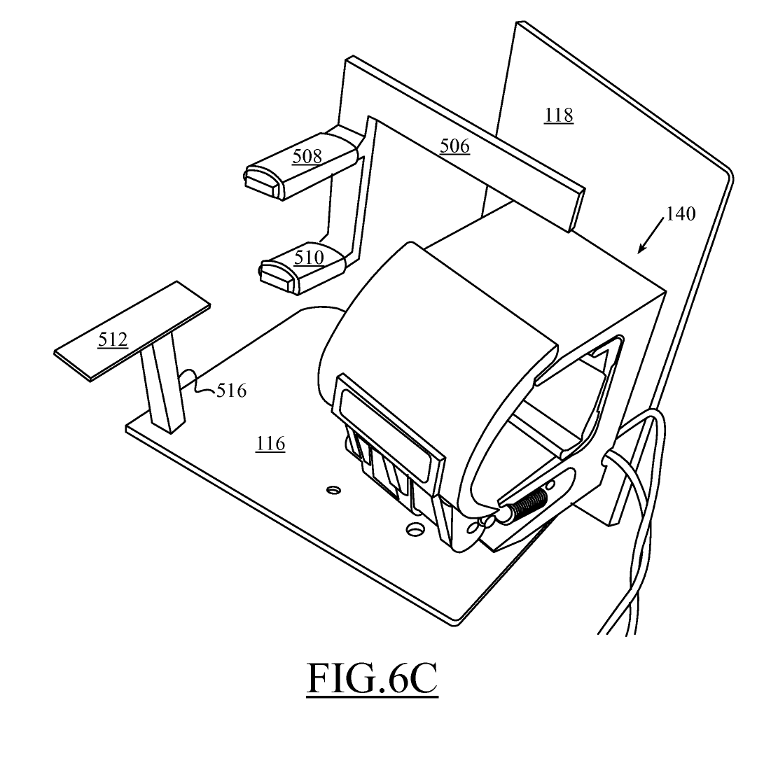

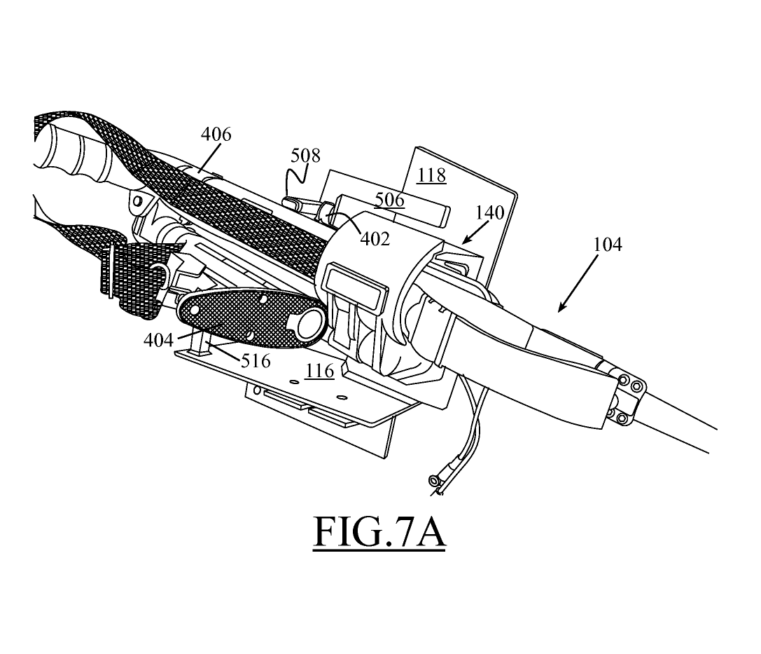

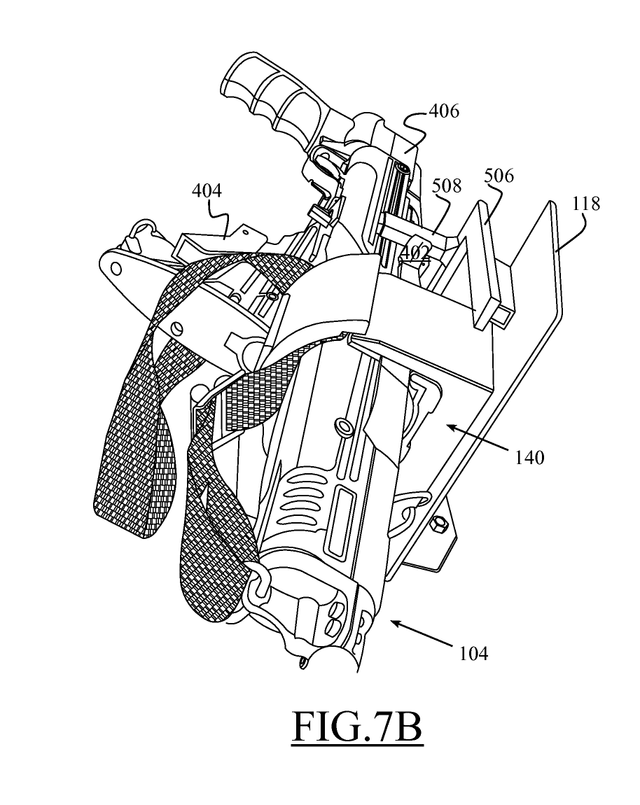

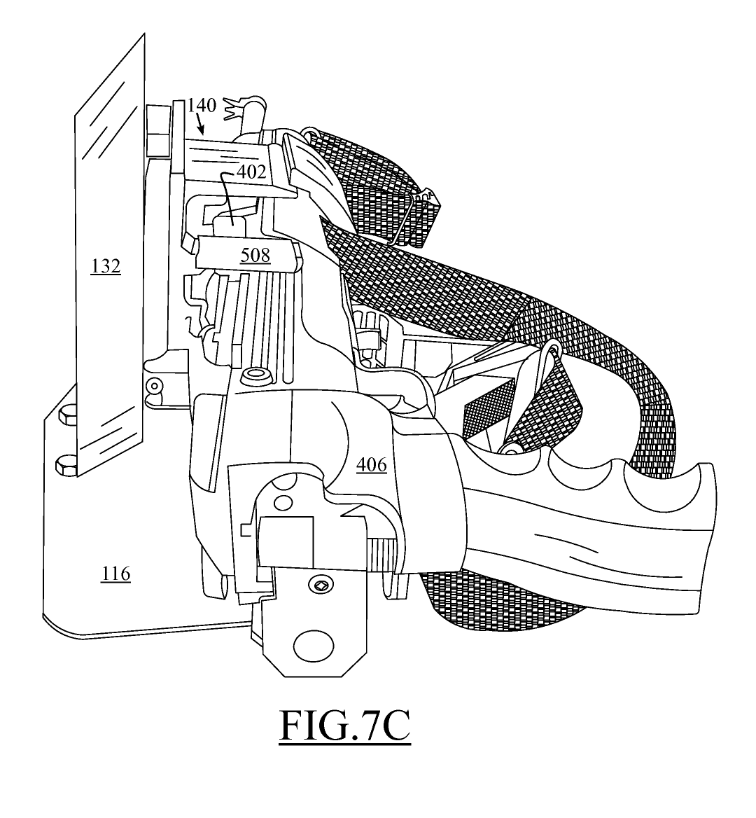

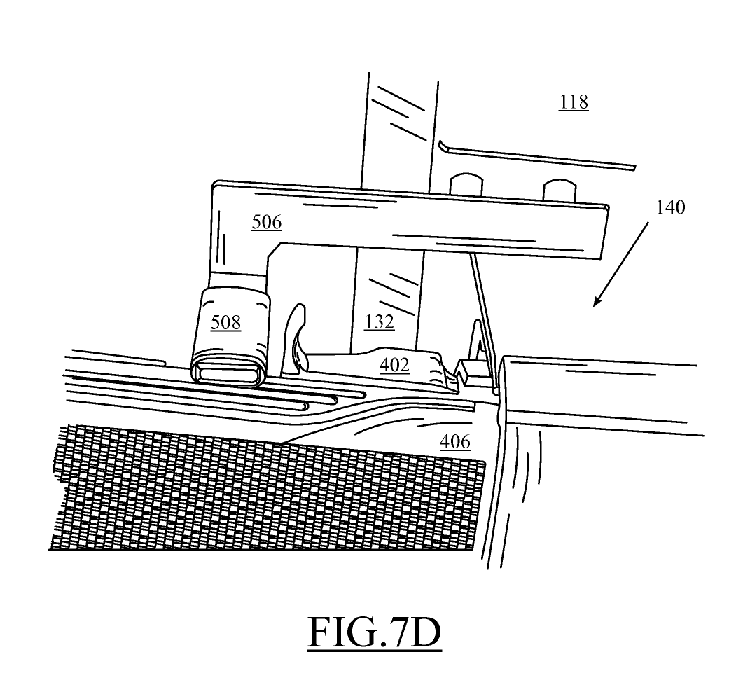

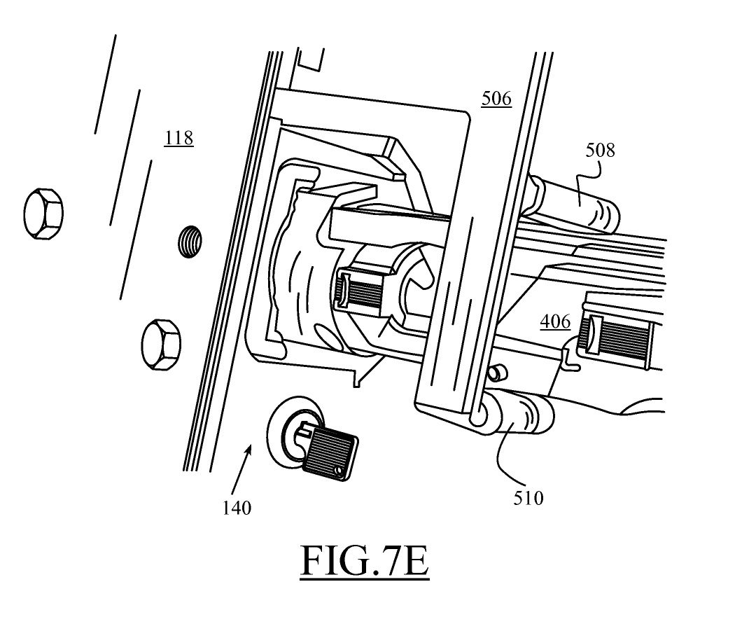

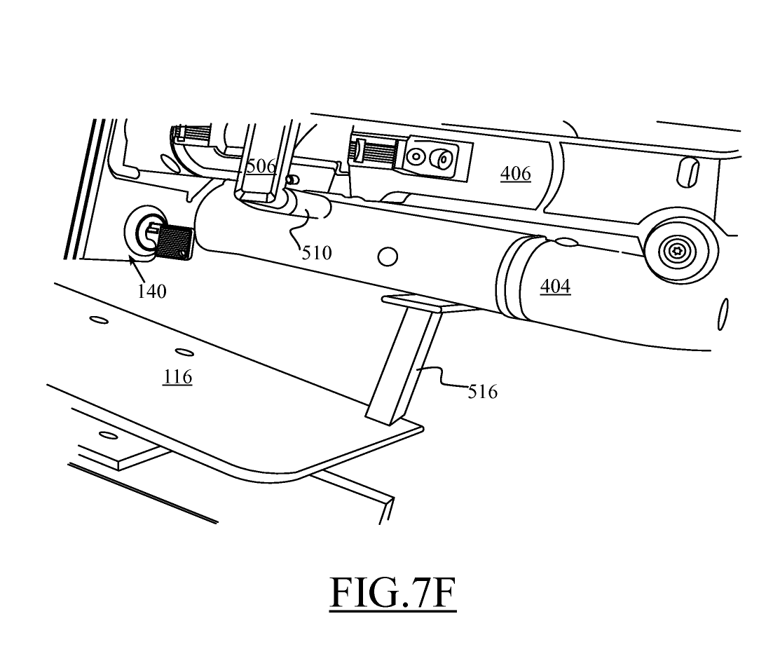

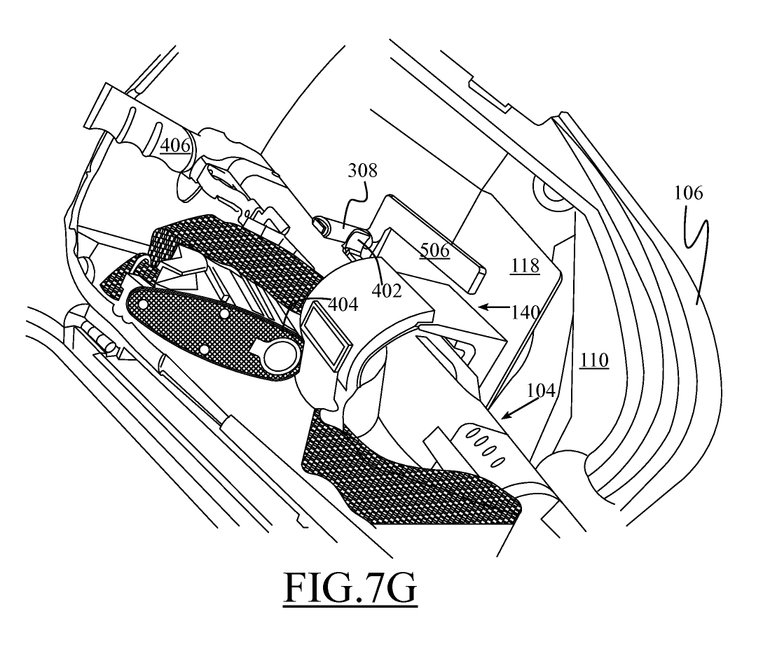

FIGS. 5A to 5E are non-limiting exemplary illustrations of the various views of another embodiment of a rack lock safety mechanism 500 in accordance with the present invention, but without the lock mechanism. FIGS. 6A to 6C are non-limiting exemplary illustrations of the various views of the rack lock safety mechanism of FIGS. 5A to 5E, including a lock mechanisms mounted thereon in accordance with the present invention. FIGS. 7A to 7G are non-limiting exemplary illustrations of the various views of the rack lock safety mechanism of FIGS. 5A to 6C, including a weapon mounted thereon in accordance with the present invention.

The rack lock safety mechanism 500 shown in FIGS. 5A to 7G includes similar corresponding or equivalent components, interconnections, and or cooperative relationships as the rack lock safety mechanism 100 that is shown in FIGS. 1A to 4E, and described above. Therefore, for the sake of brevity, clarity, convenience, and to avoid duplication, the general description of FIGS. 5A to 7G will not repeat every corresponding or equivalent component, interconnections, and or cooperative relationships that has already been described above in relation to rack lock safety mechanism 100 that is shown in FIGS. 1A to 4E.

As illustrated in FIGS. 5A to 7G, the main frame 502 of the rack lock safety mechanism 500 does not have a top mount. Further, the lock mechanism 140 is coupled with the stand 118 of the main frame 502. It should be noted that the lock mechanism 140 could be mounted onto the main frame (302 or 502) in straight orientation so that the weapon 104 is mounted straight (parallel) with the base 116 rather than at an angle. The reason for the sloping or angular orientation of the lock mechanism 140 is simply to best accommodate the teardrop casing configuration. Shortening the height of the stand 118 and lowering the connection elevation of the lock mechanism 140 will also allow the lock mechanism 140 to be coupled with the main frame (302 or 502) in a straight orientation (parallel the base 116). Further, if the height of the stand 118 is shortened to clear the hard casing 102 interior, upper side 318 of the stand 118 need not be at an angle, but can be horizontal, substantially parallel to the base 116. It should be noted that the lock mechanism 140 may also be coupled with the base 116 rather than the stand 118. The weapon 104 itself may be mounted within the lock mechanism 140 by any means that is permitted by the lock mechanism 140.

As further illustrated in FIGS. 5A to 7G, the safety-lock module 504 of the rack lock safety mechanism 500 is configured to block and prevent removal or loading of the weapon 104. In this exemplary instance, the same weapon 104 is used for illustration. In this exemplary instance, the safety-lock module 504 is comprised of a safety lock bar 506 that is configured as an L-shaped cantilever that is coupled with stand 118. The safety lock bar 506 includes two flanges 508 and 510 that maintain the weapon 104 at a locked position. The a first flange 508 is configured to prevent an actuation of a loading mechanism 402 of the locked weapon 104. The first flange 508 is shaped over the rifle and locks the sliding bolt (lock mechanism 402) in the closed position.

As further illustrated in FIGS. 5A to 7G, the safety lock module 504 further includes the second flange 510 (of the safety lock bar 506) in combination with an alignment support 512 and 516 configured to maintain the locked weapon 104 aligned along the hollow lock chamber 146 of the lock mechanism 140. This alignment support 512 and 516 is shaped as a “table” to allow the folding rear stock section (butt) 404 to securely rest thereon in place, with the front stock 404 of the weapon 104 securely resting on the second flange 510 and within the lock mechanism 140.

FIGS. 8A to 8C are non-limiting exemplary illustrations of the various views of an external support in accordance with the present invention. As stated above, an external support 800 is used to couple with the hard casing 102 for supporting a weight of the hard casing 102, including the securely locked weapon 104 locked within the rack lock safety mechanism 100 or 500 that is mounted within the hard casing 102. As stated above, the external support 800 is mounted on a lower portion of a frame 810 of a motorcycle, near an exhaust of the motorcycle (FIG. 8C), with the external support 800 comprised of a support bar 802 along an axial length of the external support 800, and a support bracket 804 along an axial width of the external support 800 that is coupled along a transverse length of the support bar 802.

The support bar 802 is comprised of a bar length that defines the axial length of the external support 800, a bar thickness that defines the transverse length of the support bar. As best illustrated in FIG. 8A, the bar height is longitudinally along the axial length of the external support 800 from a connecting end 806 of the support bar 802, with the connected end 806 defining a bar connecting aperture. As best illustrated in FIG. 8B, the support bar 802 may optional have a bar height that progressively decreases longitudinally along the axial length of the external support 800 from a connecting end 806 of the support bar 802, with the connected end 806 defining a bar connecting aperture oriented transverse the axial length of the support bar 802.

The support bracket 804 is comprised of a bracket length that defines the axial width of the external support 800, a bracket center section that is attached to the support bar; and, and bracket apertures at longitudinal distal ends of the support bracket 804 that are used to connect a bottom of the hard casing to external support 800 using a set of fasteners. The coupling location of the external support 800 with the hard casing 102 depends on the design and shape of the hard casing 102, and further, should not be limited to only the lower portion of the frame of the motorcycle.

It should be noted that the rectangular configuration of the support bracket shown is only for illustration purpose, and should not be limiting. Non-limiting examples of other support bracket shapes that may be used may include other configurations such as circular disc or oval, square brackets, or any polygonal shape, and so on. Further, the number of brackets need not be limited to the two illustrated, but could be only one or more than two.

As further illustrated, the bracket apertures are used to connect an exterior bottom of the hard casing to external support using a set of screws. The hard casing 102 has a commensurate number of apertures to enable the connection of the external support. That is, the bracket apertures are aligned with the hard case apertures (including the base 116 of the rack lock safety mechanism), and then a set of fasteners are passed through the aligned apertures to securely mount the hard case 102 to the external support 800.

Although not illustrated, the rack lock safety mechanism of the present invention may be used with a portable casing. That is, a portable hard casing for carrying a locked and substantially concealed weapon, with the illustrated and described rack lock safety mechanism for securely locking the weapon, with the rack lock mechanism mounted within the portable hard casing to maintain the securely locked weapon substantially concealed, out of view of public, and out of elements.

In addition, the present invention may be practiced without the hard casing. That is, the present invention provides a stand-alone rack lock safety mechanism for securely locking a weapon, with the rack lock safety mechanism mounted on a hard-top or even within a stand-alone hard casing to maintain the securely locked weapon substantially concealed, out of view of public, and out of elements. It should be noted that in this exemplary instance, the rack lock safety mechanism need not have a configuration that is sloped, but can be straight. In addition, there would be no need for a brace or a tie-down connector.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. For example, the safety lock module and the lock mechanism may be coupled with any section of the main frame. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. A device, comprising:
a hard casing for carrying a locked and substantially concealed weapon;
a rack lock safety mechanism for securely locking the weapon, with the rack lock safety mechanism mounted within the hard casing to maintain the securely locked weapon substantially concealed, out of view of public, and out of elements.

2. The device as set forth in claim 1, further comprising:
an external support coupled with the hard casing for supporting a weight of the hard casing, including the securely locked weapon locked within the rack lock safety mechanism that is mounted within the hard casing.

3. The device as set forth in claim 2, wherein:
the hard casing includes a lateral end with an opening to enable a small portion of the weapon to extend out.

4. The device as set forth in claim 3, wherein:
the rack lock safety mechanism is mounted within the hard casing using fasteners, with the hard casing securely mount onto the external support.

5. The device as set forth in claim 1, wherein:
the rack lock safety mechanism is comprised of:
a main frame,
a safety-lock module; and
a lock mechanism.

6. The device as set forth in claim 5, wherein:
the main frame is comprised of:
a base with a base-width and a base-length providing sufficient base-span for stability of the rack lock safety mechanism to withstand forces, with the base having a base-perimeter configured commensurate with accommodations provided by an interior bottom of the hard casing.

7. The device as set forth in claim 6, wherein:
the main frame is further comprised of a stand coupled with the base;
the stand supports weight of the lock mechanism and the weapon at an elevation from the base.

8. The device as set forth in claim 7, wherein:
the stand is comprised of:
a first and second periphery edges that are coupled with the base-stand, a bottom edge coupled with the base, and a top edge.

9. The device as set forth in claim 7, wherein:
the main frame is further comprised of:
a brace for added support for added structural integrity for the stand, providing added strength to prevent the stand from being bent.

10. The device as set forth in claim 5, wherein:
the lock mechanism is coupled with the main frame.

11. The device as set forth in claim 5, wherein:
the safety-lock module is configured to block and prevent removal or loading of the weapon.

12. The device as set forth in claim 5, wherein:
the safety-lock module is configured to block and prevent removal and loading of the weapon.

13. The device as set forth in claim 5, wherein:
the safety-lock module is comprised of:
a first section configured to prevent an actuation of a loading mechanism of the locked weapon; and
a second section configured to prevent the removal of the locked weapon from the lock mechanism.

14. The device as set forth in claim 5, wherein:
the main frame is further comprised of:
an alignment support.

15. The device as set forth in claim 2, wherein:
the external support is, comprised of:
a support bar and a support bracket.

16. The device as set forth in claim 1, wherein:
the hard casing is comprised of a first piece that mounts on a motorcycle that is pivotally coupled with a second piece by a hinge mechanism that is positioned longitudinally along an axial length of the hard casing;
the first piece includes a lateral end with an opening to enable a small portion of the weapon to extend out, with the second piece having an auxiliary cover that conceals and protects the extended small portion of the weapon.

17. A portable device, comprising:
a portable hard casing for carrying a locked and substantially concealed weapon;
a rack lock mechanism for securely locking the weapon, with the rack lock mechanism mounted within the portable hard casing to maintain the securely locked weapon substantially concealed, out of view of public, and out of elements.

18. A rack lock safety mechanism for securely locking a weapon, comprising:
a main frame,
a safety-lock module coupled with the main frame; and
a lock mechanism coupled with the main frame.

19. The rack lock safety mechanism for securely locking a weapon as set forth in claim 18, wherein:
the main frame is comprised of:
a base having sufficient expanse for stability of the rack lock safety mechanism to withstand various forces;
a stand coupled with the base; and
a brace coupled with the stand for added support.

20. The rack lock safety mechanism for securely locking a weapon as set forth in claim 18, wherein:
the safety-lock module is configured to block and prevent removal or loading of the weapon.
